(19) United States
(12) Patent Application Publication
(10) Pub. No.: US 2024/0324030 A1
(43) Pub. Date: Sep. 26, 2024

(54) COMMUNICATION APPARATUS AND COMMUNICATION METHOD FOR MULTI-GENERATION RANDOM ACCESS

(71) Applicant: Panasonic Intellectual Property Corporation of America, Torrance, CA (US)

(72) Inventors: Rojan CHITRAKAR, Singapore (SG); Yoshio URABE, Nara (JP); Yanyi DING, Singapore (SG)

(21) Appl. No.: 18/578,157

(22) PCT Filed: May 30, 2022
(86) PCT No.: PCT/SG2022/050365

§ 371 Date: Jan. 10, 2024

(30) Foreign Application Priority Data
Jul. 16, 2021 (SG) 10202107833P

(51) Int. Cl. H04W 74/0833; H04L 5/00; H04W 72/02; H04W 72/51

(52) U.S. Cl. CPC H04W 74/085; H04L 5/0007; H04W 72/02; H04W 72/51

(57) ABSTRACT

The present disclosure provides a communication apparatus and a communication method for multi-generation random access, the communication apparatus comprising: a receiver which, in operation, receives, from a base communication apparatus, an uplink OFDMA (Orthogonal Frequency Division Multiple Access) based random access (UORA) parameter and a trigger frame comprising user information fields allocating a plurality of random access resource units (RA-RUs); and circuitry which is configured to, in operation, derive a contention window parameter from the UORA parameter based on an operating bandwidth of the communication apparatus, determine an UORA result to access the plurality of RA-RUs based on the contention window parameter and select one RA-RU from the plurality of RA-RUs according to the determination; and a transmitter which, in operation, transmits an uplink signal on the one RA-RU.

### BACKGROUND

The present disclosure generally relates to communication apparatuses, and more particularly relate to methods and apparatuses for multi-generation random access.

In the standardization of next-generation Wireless Local Area Network (WLAN) technologies, a new radio access technology having backward compatibility with earlier standards, such as Institute of Electrical and Electronics Engineers (IEEE) 802.11 a/b/g/n/ac/ax technologies, has been discussed.

In 802.11be, a same trigger frame may be used by an access point (AP) to solicit uplink transmissions from stations (STAs) of multiple generations. However, since STAs of older generation (e.g. high efficiency (HE) STAs) will have narrower operating bandwidth, they will have much fewer random access resource units (RA-RUs) to contend and thus has less chances of winning an uplink OFDMA (Orthogonal Frequency Division Multiple Access) based random access (UORA) parameter contention as compared to STAs of newer generation (EHT STAs or STAs with amendments after EHT (hereinafter referred to as EHT+ STAs in the present disclosure)). The probability of collision is also higher in the RA-RUs allowed to the STAs of older generation if STAs of newer generation also contend for those RA-RUs.

There is thus a need for a communication apparatus and a communication method for multi-generation random access to solve the above-mentioned issues of fairness and uneven distribution of collision probability as well as potential signaling issues if padding field is used to demarcate RA-RUs allocated for new generation STAs. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for multi-generation random access.

In a first aspect, the present disclosure provides a communication apparatus comprising: a receiver which, in operation, receives, from a base communication apparatus, an uplink OFDMA (Orthogonal Frequency Division Multiple Access) based random access (UORA) parameter and a trigger frame comprising user information fields allocating a plurality of random access resource units (RA-RUs); and circuitry which is configured to, in operation, derive a contention window parameter from the UORA parameter based on an operating bandwidth of the communication apparatus, determine an UORA result to access the plurality of RA-RUs based on the contention window parameter and select one RA-RU from the plurality of RA-RUs according to the determination; and a transmitter which, in operation, transmits an uplink signal on the one RA-RU.

In a second aspect, the present disclosure provides a base communication apparatus comprising: circuitry which is configured to, in operation, generate a trigger frame comprising user information fields allocating a plurality of RA-RUs, the user information fields allocating one or more first RA-RUs allocated for a first type of communication apparatuses, and the user information fields further allocating one or more second RA-RUs allocated for a second, different type of communication apparatuses; a transmitter which, in operation, transmits an UORA parameter and the trigger frame to one or more communication apparatuses.

In a third aspect, the present disclosure provides a communication method comprising: receiving an UORA parameter and a trigger frame comprising user information fields allocating a plurality of RA-RUs; deriving a contention window parameter from the UORA parameter based on an operating bandwidth; determining an UORA result to access the plurality of RA-RUs based on the contention window parameter; selecting one RA-RU from the plurality of RA-RUs according to the determination; and transmitting an uplink signal on the one RA-RU.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1A shows a trigger frame used for allocating (frequency) resources for an uplink transmission.

FIG. 1B shows an enhanced trigger frame used for allocating resources for an uplink transmission.

FIG. 2 shows a common information (Common Info) field of the trigger frame of FIG. 1A and the enhanced trigger frame of FIG. 1B.

FIG. 3 shows a special user information (User Info) field of the trigger frame of FIG. 1A and the enhanced trigger frame of FIG. 1B.

FIG. 4A shows an EHT variant User Info field of a User Info field of the trigger frame of FIGS. 1A and 1B.

FIG. 4B shows an HE variant User Info field of a User Info field of the trigger frame of FIGS. 1A and 1B.

FIG. 5 shows a flow diagram illustrating uplink OFDMA based random access (UORA) signal communications between an AP and HE STAs through two trigger frames and two tables illustrating a change in an OFDMA backoff (OBO) counter of each STA upon receiving the two trigger frames respectively.

FIG. 6 shows a conventional trigger frame used for allocating resources to HE STAs and EHT STAs for uplink transmissions.

FIG. 7 shows a diagram illustrating an RA-RUs allocation for HE STAs, EHT STAs and EHT+ STAs by a trigger frame for an uplink operation according to an embodiment of the present disclosure.

FIG. 8 shows a trigger frame and its RA-RUs allocation for STAs of different generations according to an embodiment of the present disclosure.

FIG. 9 shows an example basic service set comprising an AP and STAs of three different generations.

FIG. 10 shows a schematic diagram illustrating an example configuration of a communication apparatus for multi-generation random access in accordance with the present disclosure.

FIG. 11 shows a flow chart illustrating a communication method for multi-generation random access according to various embodiments of the present disclosure.

FIGS. 12A and 12B show two UORA Parameter set element formats according to a first embodiment of the present disclosure.

FIG. 13 shows a User Info field of a trigger frame according to the first embodiment of the present disclosure.

FIG. 14 shows an RA-RUs allocation for STAs of different generations by a trigger frame according to the first embodiment of the present disclosure.

FIG. 15 shows a flow diagram illustrating a UORA procedure of an HE STA, an EHT STA and an EHT+ STA and a table illustrating a change in an OBO counter of each STA upon receiving a trigger frame(s), an allocation of RA-RUs by the trigger frame(s) and a selection of an RA-RU by each STA for its uplink signal 1504 according to the first embodiment of the present disclosure.

FIG. 16 shows a User Info field of a trigger frame according to a second embodiment of the present disclosure.

FIG. 17 shows a trigger frame and its RA-RUs allocation for STAs of different generations according to the second embodiment of the present disclosure.

FIG. 18 shows a special User Info field of a trigger frame according to the second embodiment of the present disclosure.

FIG. 19 shows an RA-RUs allocation for HE STAs, EHT STAs and EHT+ STAs by a trigger frame and a graph illustrating a probability of selecting each RA-RU from the allocated RA-RUs by an EHT+ STA according to the second embodiment of the present disclosure.

FIG. 20 shows a flow diagram illustrating an allocation of RA-RUs by a trigger frame and a selection of an RA-RU by an HE STA, an EHT STA and an EHT+ STA for its uplink signal according to the second embodiment of the present disclosure.

FIG. 21 shows a UORA Parameter element format according to the second embodiment of the present disclosure.

FIG. 22 shows a flow chart illustrating a UORA procedure carried out by an EHT STA according to the second embodiment of the present disclosure.

FIG. 23 shows a flow diagram illustrating a UORA procedure of an HE STA, an EHT STA and an EHT+ STA and a table illustrating a change in an OBO counter of each STA upon receiving a trigger frame(s), an allocation of RA-RUs by the trigger frame(s) and a selection of an RA-RU by each STA for its uplink signal according to the second embodiment of the present disclosure.

FIG. 24 shows a trigger frame and an allocation of individually addressed RU(s) and RA-RU(s) for STAs of different generations according to the second embodiment of the present disclosure.

FIG. 25 shows an example Padding User Info field of a trigger frame according to a third embodiment of the present disclosure.

FIG. 26 shows a trigger frame and its RA-RUs allocation for STAs of different generations according to the third embodiment of the present disclosure.

FIG. 27 shows a flow diagram illustrating a UORA procedure of an HE STA, an EHT STA and an EHT+ STA and a table illustrating a change in an OBO counter of each STA upon receiving a trigger frame(s), an allocation of RA-RUs by the trigger frame(s) and a selection of an RA-RU by each STA for its uplink signal according to the third embodiment of the present disclosure.

FIG. 28 shows a trigger frame and an allocation of individually addressed RU(s) and RA-RU(s) for STAs of different generations according to the third embodiment of the present disclosure.

FIGS. 29A and 29B show an RA-RUs allocation for HE STAs, EHT STAs and EHT+ STAs by a trigger frame according to a fourth embodiment of the present disclosure.

FIG. 30 shows a flow chart illustrating a UORA procedure carried out by an EHT STA according to the fourth embodiment of the present disclosure.

FIG. 31 shows a flow diagram illustrating a UORA procedure of an HE STA, an EHT STA and an EHT+ STA and a table illustrating a change in an OBO counter of each STA upon receiving a trigger frame(s), an allocation of RA-RUs by the trigger frame(s) and a selection of an RA-RU by each STA for its uplink signal 3104 according to the fourth embodiment of the present disclosure.

FIG. 32 shows respective RA-RU allocations for HE STAs, EHT STAs and EHT+ STAs by three trigger frames transmitted in OFDMA manner according to the fourth embodiment of the present disclosure.

FIG. 33 shows two trigger frames transmitted in OFDMA manner and their RA-RUs allocation for EHT STAs and EHT+ STAs, respectively, according to the fourth embodiment of the present disclosure.

FIG. 34 shows a flow diagram illustrating multiple UORA procedures of an EHT+ STA and a table illustrating a change in OBO counters of the EHT+ STA upon receiving a trigger frame(s), an allocation of RA-RUs by the trigger frame(s) and a selection of an RA-RU by the EHT+ STA for its uplink signal according to a fifth embodiment of the present disclosure.

FIG. 35 shows an example configuration of a base communication apparatus. The communication apparatus is implemented as an AP for multi-generation random access in accordance with the present disclosure.

FIG. 36 shows an example configuration of a communication apparatus. The communication apparatus is implemented as a STA for multi-generation random access in accordance with the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help an accurate understanding of the present embodiments.

### DETAILED DESCRIPTION

The following detailed description is merely exemplary in nature and is not intended to limit the embodiments or the application and uses of the embodiments. Furthermore, there is no intention to be bound by any theory presented in the preceding Background or this Detailed Description. Furthermore, other desirable features and characteristics will become apparent from the subsequent detailed description and the appended claims, taken in conjunction with the accompanying drawings and this background of the disclosure.

In the context of IEEE 802.11 (Wi-Fi) technologies, a station, which is interchangeably referred to as a STA, is a communication apparatus that has the capability to use the 802.11 protocol. Based on the IEEE 802.11-2020 definition, a STA can be any device that contains an IEEE 802.11-conformant media access control (MAC) and physical layer (PHY) interface to the wireless medium (WM).

For example, a STA may be a laptop, a desktop personal computer (PC), a personal digital assistant (PDA), an access point or a Wi-Fi phone in a wireless local area network (WLAN) environment. The STA may be fixed or mobile. In the WLAN environment, the terms “STA”, “wireless client”, “user”, “user device”, and “node” are often used interchangeably.

Likewise, an AP, which may be interchangeably referred to as a wireless access point (WAP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router. In various embodiments below an AP may be referred to as a base communication apparatus.

As mentioned above, a STA in a WLAN may work as an AP at a different occasion, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

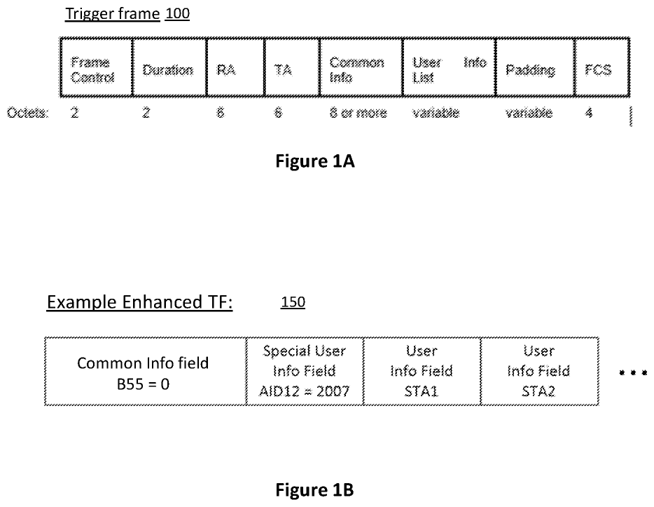

IEEE 802.11be has approved concept of frequency domain aggregated (A)-PPDU (PLCP (Physical Layer Convergence Protocol) Protocol Data Unit). A trigger frame allocates different frequency segments (e.g., respective 80 MHz frequency segments) to be used by STAs of different generations for their UL operations. The signaling support for A-PPDU is illustrated in FIGS. 1-4B. FIG. 1A shows a trigger frame 100 used for allocating (frequency) resources (hereinafter referred to as “resource units” or “RU”) for uplink transmission such as an trigger based A-PPDU. The trigger frame 100 comprise a Frame Control field (with 2 octets), a Duration field (with 2 octets), a Recipient Address (RA) field (with 6 octets), a Transmitter Address (TA) field (with 6 octets), a Common Info (Information) field (with 8 or more octets), a User Info List field (with a variable number of octets), optionally a Padding field (with a variable number of octets) and a Frame Check Sequence (FCS) field (with 4 octets). The User Info field of the trigger frame 100 may comprise a Special User Info field and one or more User Info fields.

FIG. 1B shows an enhanced trigger frame 150 used for allocating resources for uplink transmission. The enhanced trigger frame 150 is a special example of the Trigger frame 100 and may comprise a Common Info field, a Special Info field and one or more User Info fields, and may be used to allocate resources to communication apparatus of different 802.11 generations (or amendments e.g., 11ax, 11be etc.). The presence of the Special Info field in the trigger frame is indicated by the Bit 55 of the Common Info field set to 0. The Special Info field, if present, is located immediately after the Common Info field. The Special User Info field carries the non-derived subfields of the U-SIG field of a solicited EHT TB PPDU.

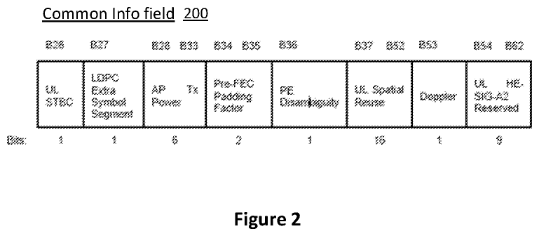

FIG. 2 shows a Common Info field 200 of the trigger frame 100 of FIG. 1A or FIG. 1B and the enhanced trigger frame 150 of FIG. 1B. The Common Info field 200 comprises a UL Space-time block code (STBC) field, a Low Density Parity Check Code (LDPC) Extra Symbol Segment field, a AP Transmission (Tx) Power field, a Pre-FEC (Forward Error Correction) Padding Factor field, Packet Extension (PE) Disambiguity field, a UL Spatial Reuse field, a Doppler field, and a UL HE-SIG-A2 Reserved field, the fields comprising 1, 1, 6, 2, 1, 16, 1 and 9 bits at bit numbers 26, 27, 28 to 33, 34 to 35, 37 to 52, 53 and 54 to 62 (denoted as B26, B27, B28 to B33, B34 to B35, B36, B37 to B52, B53 and B54 to B62) of the Common Info field 200 respectively. An EHT AP is configured to set B54 to 0 or 1 to indicate to an EHT STA that the solicited TB PPDU is an EHT TB PPDU or an HE TB PPDU, respectively. The presence of the Special Info field in the trigger frame is indicated by the Bit 55 of the Common Info field set to 0.

B54 of the Common Info field 200 can be used to indicate which type/generation of STAs is signed to use the primary 160 MHz frequency segment (P160). In other words, it can be used for soliciting an HE or EHT TB PPDU in the P160. When B54 is set to 1, HE STAs will be assigned to use the P160, the trigger frame soliciting an HE TB PPDU in the P160; whereas when B54 is set to 0, EHT STAs will be assigned to use the P160, the trigger frame soliciting an EHT TB PPDU in the P160. B55 of the Common Info field 200 can be used to indicate a presence of a Special User Info field in a trigger frame. When B55 is set to 1, it means there is no Special User Info field in the trigger frame; whereas when B55 is set o 0, it means a Special Info field is present is the trigger frame.

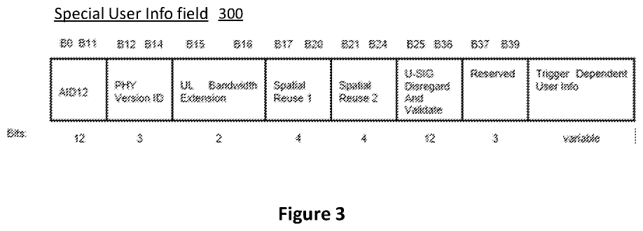

FIG. 3 shows a Special User Info field 300 the trigger frame 100 of FIG. 1A and the enhanced trigger frame 150 of FIG. 1B. The Special User Info field 300 comprises an AID12 subfield (set to a value of 2007), a PHY (physical) Version ID (identifier) subfield, a UL Bandwidth Extension subfield, a Spatial Reuse 1 subfield, a Spatial Reuse 2 subfield and a U-SIG Disregard And Validate subfield, the subfields comprising 12, 3, 2, 4, 4, 12 bits at bit numbers 0 to 11, 12 to 14, 15 to 16, 17 to 120, 21 to 24 and 25 to 36 (denoted as B0 to B11, B12 to B14, B15 to B16, B17 to B20, B21 to B24 and B25 to B36) of the Special User Info field 300 respectively The Special User Info field 300 may further comprise a Trigger Dependent User Info subfield with a variable number of bits after 3 reserved bits at B37 to B39. The Special User Info field carries the non-derived subfields of the U-SIG field of a solicited EHT TB PPDU.

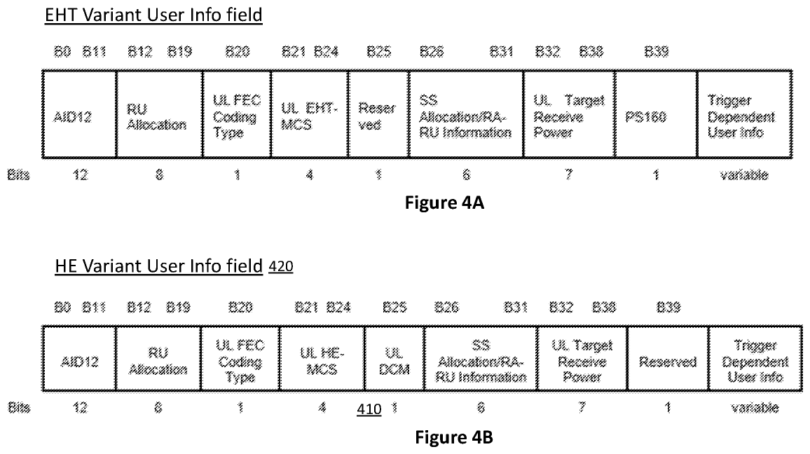

A User Info field, e.g. in the User Info List field of the trigger frame 100 and that of the enhanced trigger frame 150, is an EHT Variant User Info field as indicated by the combination of B54 and B55 of the Common Info field and B39 of the User Info field as illustrated in Table 1, otherwise it is an HE variant User Info field. The EHT Variant User Info field is intended to be used by EHT non-AP STAs. FIG. 4A shows an EHT variant User Info field 410 of the trigger frame 100 of FIG. 1A and the enhanced trigger frame 150 of FIG. 1B. The EHT Variant User Info field comprises an AID12 subfield, a RU allocation subfield, a UL FEC Coding subfield ( ), a UL EHT-MCS (Modulation Coding Scheme) subfield, a Spatial Stream (SS) Allocation/RA-RU Information subfield, a UL Target Receive Power subfield and a PS160 subfield, the subfields comprising 12, 8, 1, 4, 6, 7, and 1 bits at bit numbers 0 to 11, 12 to 19, 20, 21 to 24, 26 to 31, 32 to 38 and 39 (denoted as B0 to B11, B12 to B19, B20, B21 to B24, B26 to B31, B32 to B38 and B39) of the EHT Variant User Info field 410 respectively. The EHT Variant User Info field 410 may further comprise a Trigger Dependent User Info subfield with a variable number of bits after the PS160 field.

If the size of RU/MRU (multi-user resource unit) is smaller than or equal to 2×996-tone, then PS160 subfield is set to 0 to indicate that RU/MRU allocation applies to the primary 160 MHz channel and set to 1 to indicate that RU/MRU allocation applies to the secondary 160 MHz channel. Otherwise, it is used to indicate the RU/MRU index along with the RU Allocation subfield.

FIG. 4B shows an HE variant User Info field 420 of the trigger frame 100 of FIG. 1A and the enhanced trigger frame 150 of FIG. 1B. The HE Variant User Info field 420 comprises an AID12 field, a RU allocation field, a UL FEC Coding field, a UL HE-MCS field, a UL Dual Carrier Modulation (DCM) field, a SS Allocation/RA-RU Information field and a UL Target Receive Power field, the fields comprising 12, 8, 1, 4, 1, 6, and 7 bits at bit numbers 0 to 11, 12 to 19, 20, 21 to 24, 25, 26 to 31 and 32 to 38 (denoted as B0 to B11, B12 to B19, B20, B21 to B24, B25, B26 to B31 and B32 to B38) of the HE Variant User Info field 420 respectively. The HE Variant User Info field 420 may further comprise a Trigger Dependent User Info field with a variable number of bits a reserve bit at B39.

Table 1 summarizes the TB PPDU types indicated by the values of B54 and B55 of the Common Info field 300 and B39 of the EHT/HE variant User Info field 410, 420 of the trigger frame 100 and the enhanced trigger frame 150. B39 of the User Info field 410, 420 can be used to indicate which User Info field variant and a RU/MRU allocation in which frequency segment. B39 is reserved and set to 0 for an HE variant User Info field; whereas for an EHT Variant (B39 is included in the PS160 field), B39 is set to 0 to indicate a RU/MRU allocation in the P160, whereas B39 is set to 1 to indicate a RU/MRU allocation in the secondary 160 MHz frequency segment (S160).

TABLE 1
Various values of B54 and B55 of the Common Info field 310 and B39 of the User
Info field 410, 420 of a trigger frame and their corresponding TB PPDU types

| Common Info | Common Info | User Info | Presence of Special | User Info field | TB PPDU |
|---|---|---|---|---|---|
| field B54 | field B55 | field B39 | User Info field | variant | type |
| 1 | 1 | 0 | No | HE variant | HE |
| 0 | 0 | 0 | Yes | EHT variant | EHT |
| 0 | 0 | 1 | Yes | EHT variant | EHT |
| 1 | 0 | 1 | Yes | EHT variant | EHT |
| 1 | 0 | 0 | Yes | HE variant | HE |

Uplink OFDMA based random access (UORA) was introduced in 802.1 lax to allow non-AP STA to content for random access resource units (RA-RUs) for uplink transmission. An HE AP may transmit a basic trigger frame, BQRP trigger frame or BSRP trigger frame that contains one or more User Info fields allocating corresponding one or more RUs for random access, where AID subfield is set to 0 and 2045 to indicate RUs allocated to (or eligible to) associated STAs and unassociated STAs respectively.

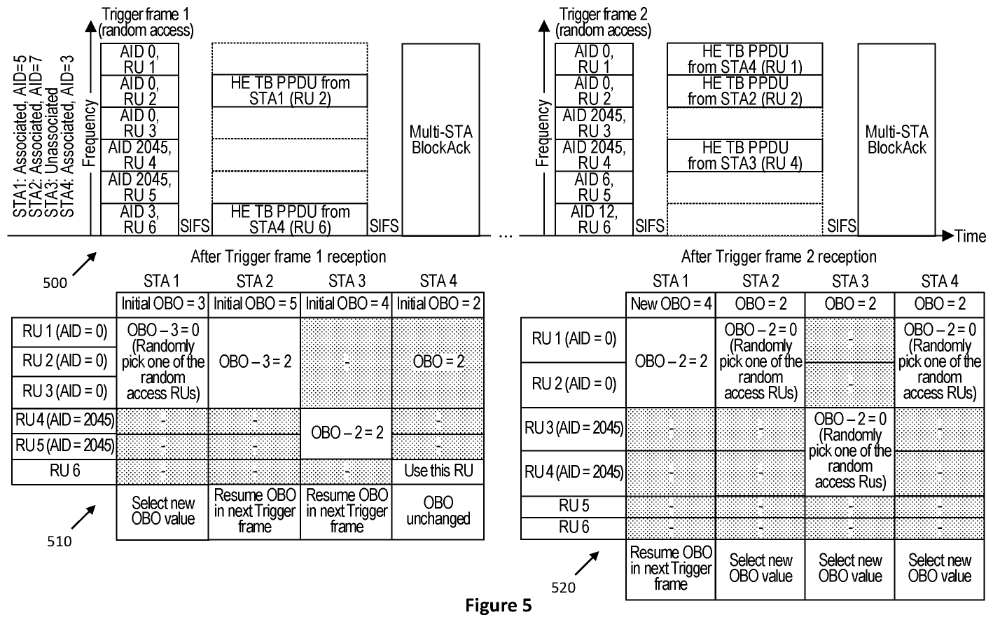

FIG. 5 shows a flow diagram 500 illustrating uplink OFDMA based random access (UORA) signal communications between an AP and HE STAs through two trigger frames and two tables 510, 520 illustrating a change in an OFDMA backoff (OBO) counter of each STA upon receiving the two trigger frames respectively. In this example, STA1, STA2, STA4 is associated with the AP with associated IDs of 5, 7, 3 respectively whereas STA3 is not associated with the AP. The gray rows under each STA's column in table 510 and table 520 represent RUs that are not eligible for their UORA contention. Only the RUs that align with the rows in white are eligible RA-RUs for the STAs.

The AP transmits a trigger frame (Trigger frame 1). The trigger frame comprises six User Info fields allocating three RA-RUs (RUs 1 to 3) for associated STAs with AID set to 0 and two RA-RUs (RUs 4 to 5) for unassociated STAs with AID set to 2045 and one individually addressed RU to an associated STA with AID set to 3 (i.e. STA4).

A non-AP STA shall not contend for an eligible RA-RU or decrement its OBO counter if it does not have pending frames for the AP. An RA-RU is considered eligible for a non-AP STA if the RA-RU is located within the operating bandwidth of the STA, the STA is not allocated an individually allocated (i.e. dedicated) RU in the same trigger frame and the STA supports all the transmit parameters indicated in the common info field that are used to transmit on the RA-RU. An HE non-AP STA that has a pending frame for the AP, upon the reception of a Trigger frame containing at least one eligible RA-RU, if the OBO counter of an HE non-AP STA is not greater than the number of eligible RA-RUs in a Trigger frame from that AP, then the HE non-AP STA shall set its OBO counter to zero and randomly select one of the eligible RA-RUs to be considered for transmission. Otherwise, the HE non-AP STA decrements its OBO counter by the number of eligible RA-RUs in the Trigger frame.

Before Trigger frame 1 is sent by the AP, HE STA 1, STA 2, STA 3 and STA 4 have initial OBO values of 3, 5, 4 and 2 respectively. Upon receiving Trigger frame 1, STA 4, which is associated with the AP and has pending frames for the AP, is allocated a dedicated RU (RU6). The STA does not contend for RA-RUs and instead transmits its pending frames on RU6.

STA 1 and STA 2, both associated with the AP and having pending frames for the AP, decrement their respective OBO counters by the number of eligible RA-RUs indicated in the Trigger frame (i.e., three RA-RUs for associated STAs). Since STA 1's OBO counter decrements to 0, it transmits its pending frames on RU2 that it randomly selects one RU from the eligible set of RUs (i.e., RU1, RU2, and RU3). Since STA 2's OBO counter decrements to a nonzero value, it maintains the new OBO value (2) until it receives a later Trigger frame carrying RA-RUs for associated STAs.

STA 3, which is not associated with the AP but has a pending frame for the AP, decrements its OBO counter by the number of eligible RA-RUs indicated in the Trigger frame (i.e., two RARUs for unassociated STAs). Since STA 3's OBO counter decrements to a nonzero value, it maintains the new OBO value (2) until it receives a later Trigger frame carrying RA-RUs for unassociated STAs.

After transmission of HE TB PPDU in response to Trigger frame 1, STA 4 has additional frames pending for the AP. Therefore, it maintains its initial OBO value (2) until it receives a later Trigger frame carrying RA-RUs for associated STAs. STA 1 has additional frames pending for the AP and randomly selects a new OBO value (4).

The AP transmits another trigger frame (Trigger frame 2). The trigger frame comprises six User Info fields allocating two RA-RUs (RUs 1 to 2) for associated STAs with AID set to 0 and two RA-RUs (RUs 3 to 4) for unassociated STAs with AID set to 2045 and two individually addressed RUs to an associated STA with AID set to 6 and 12 (not shown).

Upon receiving Trigger frame 2, STA 1, STA 2 and STA 4 decrement their respective OBO counters by number of eligible RARUs (two RA-RUs for associated STAs). Since STA 2 and STA 4's OBO counters decrements to 0, they both transmit their pending frames on a randomly selected one RU from the eligible set of RUs (i.e., RU1 and RU2), e.g. RU2 in the case of STA 2 and RU1 in the case of STA 4. If either STAs have additional frames pending for the AP, each would randomly select a new OBO value. Since STA 1's OBO decrements to a nonzero value, it maintains the new OBO value (2) until it receives a later Trigger frame carrying RA-RUs for associated STAs. STA 3 decrements its OBO counter by the number of eligible RA-RUs (two RA-RUs for associated STAs). Since the STA's OBO counter decrements to 0, it transmits its pending frame on a randomly selected one RU from the eligible set of RUs (i.e., RU3 and RU4), in this case RU4.

According to 802.11be release 2 (R2), a same trigger frame may be used to solicit both HE and EHT STAs. A possible signaling mechanism is proposed, that is, the user info fields with RA-RUs for EHT STAs are placed after User Info field used for Padding (AID12 subfield set to 4095).

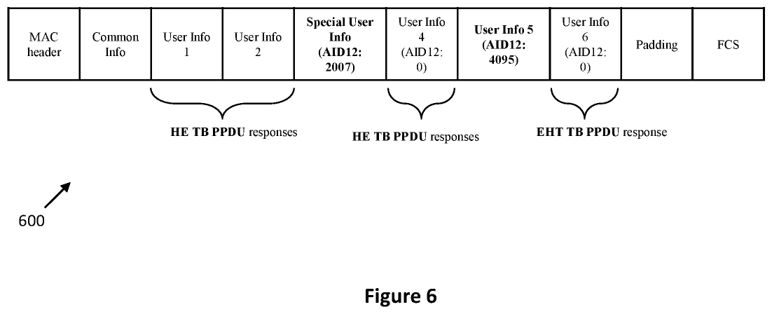

FIG. 6 shows a conventional trigger frame 600 used to allocate resources to HE STAs and EHT STAs for uplink transmissions. The trigger frame 600 comprises a media access control (MAC) header, a Common Info field, two User Info fields (User Info field 1, User Info field 2) allocating two individually addressed RUs for HE STAs which solicit HE TB PPDU responses, a Special User Info field with AID12 subfield set to 2007, a User Info field 4 allocating one RA-RU for HE STAs which solicits HE TB PPDU responses), a User Info field with its AID12 subfield set to 4095 (Padding) and a User Info field allocating RA-RUs for EHT STAs after the Padding which solicits EHT TB PPDU responses, a Padding field and a FCS field. Since HE STAs are expected to discard all fields after the padding field, they may discard the User Info field 6.

Alternatively, User Info field 6 may use new reserved AIDs (e.g. 2008, 2009) to signal RA-RUs for EHT/EHT+ STAs. In either case, HE STAs will only understand User Info 4 as RA-RU while EHT/EHT+ STAs understand both User Info 4 and User Info 6 as RA-RUs. As a result, noting that a non-AP STA may consider an RU as an eligible RA-RU if it supports all the transmit parameters indicated in the Common Info field and in the User Info field that allocates that RU, the number of eligible RA-RUs for earlier generation STAs (e.g., HE STAs) will be lesser than the number of eligible RA-RUs for newer generations STAs (e.g., EHT STAs).

As mentioned earlier, this poses a few potential problems. There are fairness issues, as HE STAs will have much fewer eligible RA-RUs to content and thus lesser chances of winning UORA contentions.

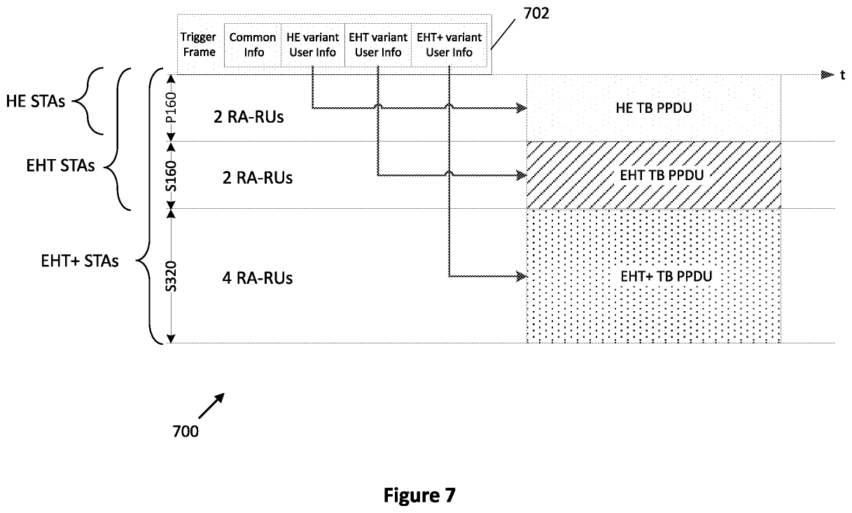

FIG. 7 shows a diagram 700 illustrating an RA-RUs allocation for HE STAs, EHT STAs and EHT+ STAs by a trigger frame 702 for an uplink operation. In all examples in this disclosure including this example, HE STAs operate in the P160 (primary 160 MHz frequency segment), EHT STAs operate in the P320 (primary 320 MHz frequency segment) which is made up of P160 and S160 (secondary 160 MHz frequency segment), while EHT+ STAs operate in 640 MHz band (made up of P320 and S320 (secondary 320 MHz frequency segment)). The trigger frame 702 allocates 2 RA-RUs in P160, 2 RA-RUs in S160 and 4 RA-RUs in S320. It is noted that the two RA-RUs in P160 are eligible RA-RUs for HE STAs, the two RA-RUs in P160 and the two RA-RUs in S160 are eligible RA-RUs for EHT STAs, while the two RA-RUs in P160, the two RA-RUs in S160 and the four RA-RUs in the S320 are eligible RA-RUs for EHT+ STAs. As a result, 2, 4 and 8 RA-RUs are eligible for HE STAs, EHT STAs and EHT+ STAs respectively.

There is also uneven distribution of collision probability, as STAs of newer generation may also contend for the RA-RUs allocated to STAs of older generation and thus create higher probability of collision in the RA-RUs allocated to the older generation. Further, there may be signaling issue, especially if Padding (User Info field with AID12 set to 4095) is used to demarcate RA-RUs for EHT/EHT+ STAs, and a new method to signal such padding may be required.

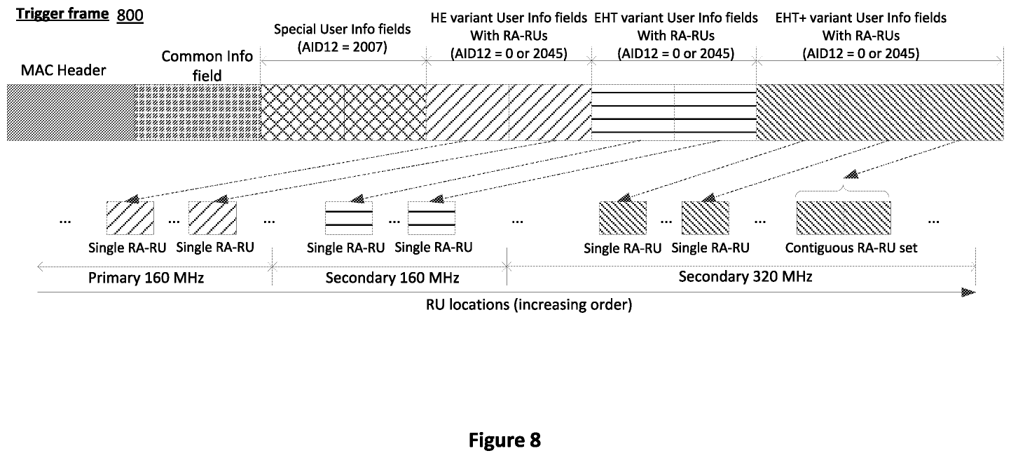

To address the issue, a User Info field with AID12 subfield set to 0 or 2045 is used to allocate RA-RUs to associated and unassociated non-AP STAs respectively regardless of their generation (HE/EHT/EHT+), and different variants of the User Info field are used to allocate RA-RUs to STAs of different generations. FIG. 8 shows a trigger frame 800 and its RA-RUs allocation for STAs of different generations according to an embodiment of the present disclosure. The trigger frame 800 comprises a MAC Header, a Common Info field with Special User Info field Present bit set to 0, two Special User Info fields with AID12 subfield set to 2007 for EHT TB PPDU and EHT+TB PPDU respectively, two HE variant User Info fields allocating two RA-RUs in the primary 160 MHz frequency segment, two EHT variant User Info fields allocating two RA-RUs in the secondary 160 MHz frequency segment and two EHT+ variant User Info field allocating two RA-RUs in the secondary 320 MHz frequency segment, respectively. The AID12 subfield of the HE/EHT/EHT+ variant User Info field is set to 0 or 2045 to allocate RA-RUs to associated or unassociated STAs respectively. Here the AP's intention is that the format of the TB PPDU transmitted in the RA-RUs are determined by the location of the RA-RU in the frequency domain, for e.g., only HE TB PPDUs are transmitted on the two RA-RUs in P160, only EHT TB PPDUs are transmitted on the two RA-RUs in the S160 and only EHT+TB PPDUs are transmitted on the RA-RUs in the S320. However, as legacy HE STAs do not understand PS160 bit, one of the drawback of this scheme is that legacy HE STAs will not understand the RU allocation of RA-RUs allocated outside the P160 and hence may interpret such RA-RUs as being located within the P160. Similarly, EHT STAs may not understand the RU allocation of RA-RUs allocated outside the P320 and hence may interpret such RA-RUs as being located within the P320. In both cases, uplink transmission may occur on the wrong RA-RU leading to collisions.

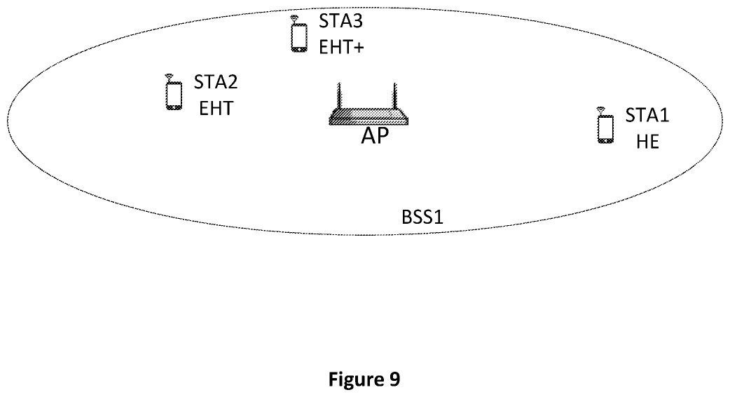

According to the present disclosure, in a basic service set serving STAs of different generations, as shown in FIG. 9, the AP advertises a common set of UORA parameters such as EOCWₘᵢₙ and EOCWₘₐₓ to be used by STAs of all generations (HE STAs like STA1, EHT STAs like STA2 and EHT+ STAs like STA3) to content for UORA. In an embodiment, the AP also advertises a bandwidth unit or a Unit_Bandwidth parameter to be used by STAs to derive the OCWₘᵢₙ and OCWₘₐₓ that are used for UORA contention. In another embodiment, the AP also advertises a weighing factor to be used by STAs during selection of an RA-RU for uplink transmissions upon winning the UORA contention, the weighing factor influencing the probability of selecting RA-RUs of different generations. The AP transmits a single Trigger frame allocating RA-RUs to STAs of different generations.

According to various embodiments of the present disclosure, upon receiving the UORA parameters and the Unit_Bandwidth parameter, a non-AP STA derives its own UORA parameter (e.g. contention window parameters OCWₘᵢₙ and OCWₘₐₓ) based on its operating bandwidth. Upon receiving the Trigger frame allocating RA-RUs, the non-AP STA may contend for UORA based on the derived UORA parameters. Upon winning UORA contention, the non-AP STA applies the weighing factors during random selection of a RA-RU for uplink transmission.

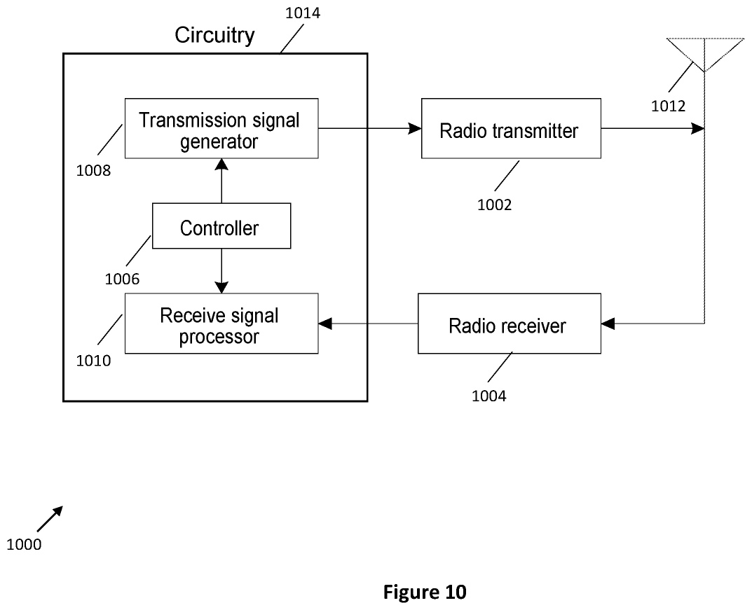

FIG. 10 shows a schematic diagram illustrating an example configuration of a communication apparatus 1000 for multi-generation random access in accordance with the present disclosure. The communication apparatus 1000 may be implemented as an AP and a STA and configured for UORA transmission in accordance with the present disclosure. As shown in FIG. 10, the communication apparatus 1000 may include circuitry 1014, at least one radio transmitter 1002, at least one radio receiver 1004, and at least one antenna 1012 (for the sake of simplicity, only one antenna is depicted in FIG. 10 for illustration purposes). The circuitry 1014 may include at least one controller 1006 for use in software and hardware aided execution of tasks that the at least one controller 1006 is designed to perform, including control of communications with one or more other communication apparatuses in a multiple input and multiple output (MIMO) wireless network. The circuitry 1014 may furthermore include at least one transmission signal generator 1008 and at least one receive signal processor 1010. The at least one controller 1006 may control the at least one transmission signal generator 1008 for generating a trigger frame and BlockAck frame to be sent through the at least one radio transmitter 1002 and the at least one receive signal processors 1010 for processing PPDU (for example HE TB PPDU, EHT TB PPDU, EHT+TB PPDU) received through the at least one radio receiver 1004 from the one or more other communication apparatuses. The at least one transmission signal generator 1008 and the at least one receive signal processor 1010 may be stand-alone modules of the communication apparatus 1000 that communicate with the at least one controller 806 for the above-mentioned functions, as shown in FIG. 10. Alternatively, the at least one transmission signal generator 1008 and the at least one receive signal processor 1010 may be included in the at least one controller 1006. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 1002, at least one radio receiver 1004, and at least one antenna 1012 may be controlled by the at least one controller 1006.

The communication apparatus 1000, when in operation, provides functions required for multi-generation random access. For example, the communication apparatus 1000 may be a STA and the at least one radio receiver 1004 may, in operation, receive from another communication apparatus (for example an AP or a base communication apparatus), an UORA based random access parameter (for example EOCWₘᵢₙ and EOCWₘₐₓ) and a trigger frame comprising User Info fields allocating a plurality of RA-Rus. The circuitry 1014 (for example the at least one receive signal processor 1010 of the circuitry 1014) may be configured to, in operation, derive a contention window parameter (for example OCWₘᵢₙ and OCWₘₐₓ) from the UORA parameter based on an operating bandwidth of the communication apparatus; determine an UORA result to access the plurality of RA-RUs based on the contention window parameter and select one RA-RU from the plurality of RA-RUs according to the determination. The at least one radio transmitter 1002 may, in operation, transmit an uplink signal on the one RA-RU.

For example, the communication apparatus 1000 may be a base communication apparatus or an AP, and the circuitry 1014 (for example the at least one transmission signal generator 1008 of the circuitry 1014) may be configured to, in operation, generate a trigger frame comprising user information fields allocating a plurality of RA-RUs, the user information fields allocating one or more first RA-RUs allocated for a first type of communication apparatuses (for example EHT STAs), and the user information fields further allocating one or more second RA-RUs allocated for a second, different type of communication apparatuses (for example HE STAs). The at least one radio transmitter 1002 may, in operation, transmit an UORA parameter (for example EOCWₘᵢₙ and EOCWₘₐₓ) and the trigger frame to one or more communication apparatuses.

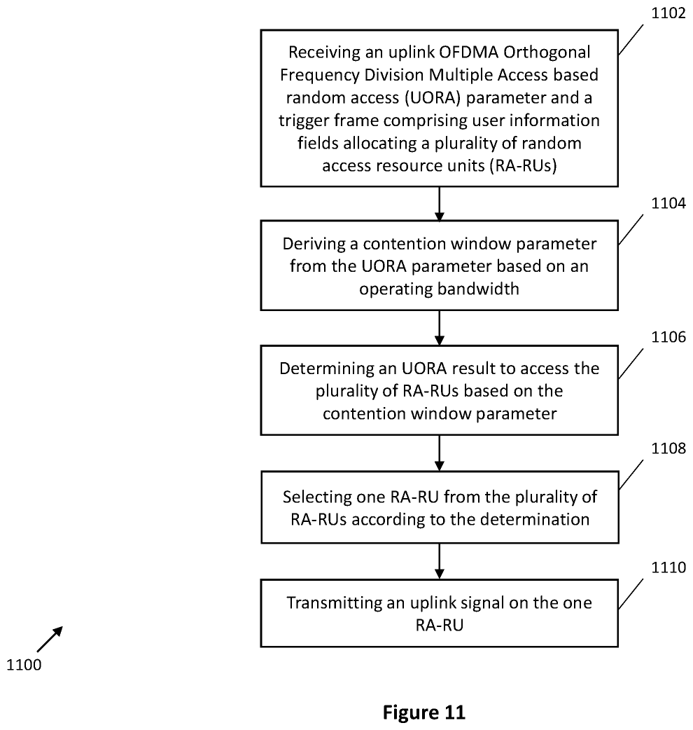

FIG. 11 shows a flow chart 1100 illustrating a communication method for multi-generation random access according to various embodiments of the present disclosure. In step 1102, a step of receiving an uplink OFDMA based random access (UORA) parameter and a trigger frame comprising user information fields allocating a plurality of random access resource units (RA-RUs) is carried out. In step 1104, a step of deriving a contention window parameter from the UORA parameter based on an operating bandwidth is carried out. In step 1106, a step of determining an UORA result to access the plurality of RA-RUs based on the contention window parameter is carried out. In step 1108, a step of selecting one RA-RU from the plurality of RA-RUs is carried out according to the determination. In step 1110, a step of transmitting an uplink signal on the one RA-RU is carried out.

In various embodiments below, RA-RUs of different generations may be called HE variant RA-RU, EHT variant RA-RU, EHT+ variant RA-RU etc. An RU is addressed as an “RA-RU for STAs of a generation” if the RU is understood as an RA-RU by STAs of that generation, e.g., an HE variant RA-RU indicated by AID 0 or AID 2045 is understood as RA-RU by STAs of all generation (HE, EHT, EHT+ etc.) hence an HE variant RA-RU represents an RA-RU for HE STAs, EHT STAs as well as EHT+ STAs. Similarly, an EHT variant RA-RU is understood as RA-RU by EHT and EHT+ STAs only and hence is an RA-RU for EHT and EHT+ STAs only but not for HE STAs. Similarly, if an EHT+RA-RU is only understood as RA-RU by EHT+ STAs and hence is called an “RA-RU for EHT+ STAs”. As long as an RA-RU indication is understood by the STAs of that generation and that RA-RU is considered an eligible RA-RU for STAs of that generation, that RA-RU is called an RA-RU for that generation.

In the following paragraphs, a first embodiment of the present disclosure is explained with reference to multi-generation random access using a new format of User Info fields for allocating RA-RUs to EHT/EHT+ STAs.

According to the first embodiment, an AP advertises, for example using a beacon frame, different OFDMA Contention Window (OCW) ranges (i.e. EOCWₘᵢₙ and EOCWₘₐₓ) for STAs of different generations, for example, HE OCW range, EHT OCW range, EHT+ OCW range, etc.. The AP may advertise lower values for older generation. By correctly adjusting the OCW ranges according to their generations, the AP can ensure that STAs of different generations have similar probability of winning UORA contention.

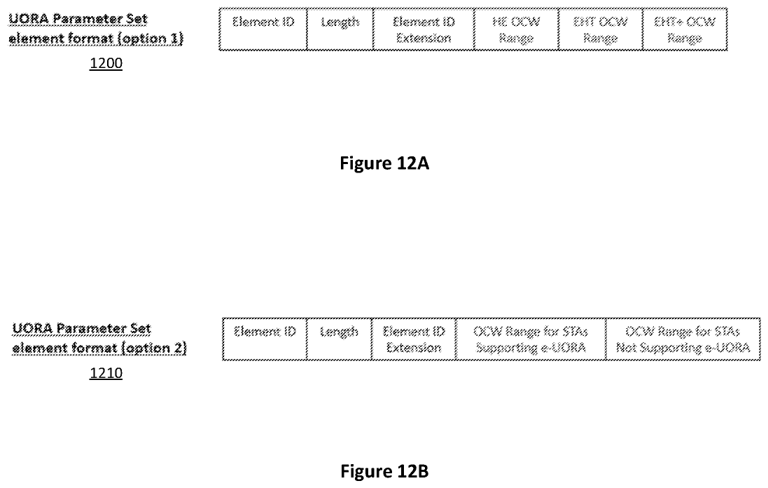

There are two options to signal the different OCW ranges. FIGS. 12A and 12B show two UORA Parameter set element formats 1200, 1210 (Option 1 and Option 2, respectively) according to the first embodiment of the present disclosure. For Option 1, the UORA Parameter set element 1200, as shown in FIG. 12A, comprises an Element ID field, a Length field, an Element ID Extension field, an HE OCW Range field carrying OCW ranges for HE STAs, an EHT OCW range field carrying OCW ranges for EHT STAs and an EHT+ OCW Range field carrying OCW ranges for EHT+ STAs. For Option 2, the UORA Parameter set element 1210, as shown in FIG. 12B, comprises an Element ID field, a Length field, an Element ID Extension field, an OCW Range for STAs Supporting e-UORA field (e.g., EHT/EHT+ STAs) and an OCW Range for STAs Not Supporting e-UORA field (e.g., HE STAs).

Subsequently, the AP may transmit a trigger frame comprising User Info fields allocating different RA-RUs. A User Info field with AID12 subfield set to 0 or 2045 is used to allocate RA-RUs to HE STAs only, while a User Info field with AID12 subfield set to a special value of 2046 (originally for unallocated RU) are repurposed to allocate RA-RUs to EHT/EHT+ STAs. As such, HE STAs will ignore such RA-RUs as unallocated RU, while EHT/EHT+ STAs can understand them as RA-RUs.

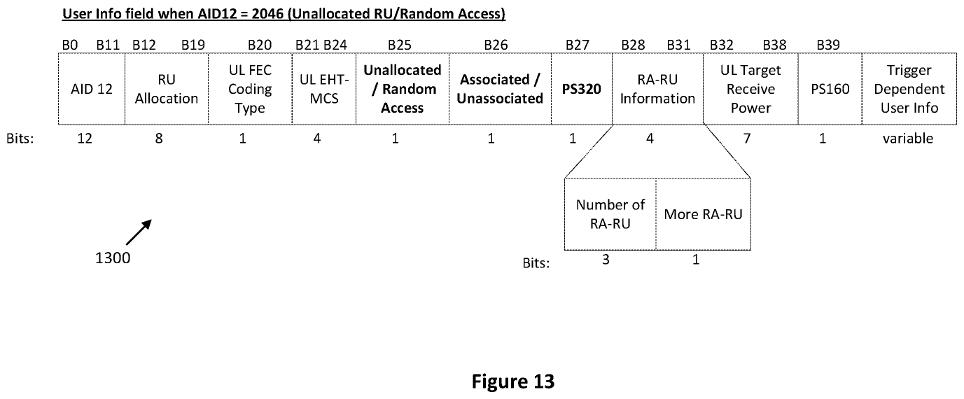

FIG. 13 shows a User Info field 1300 of a trigger frame according to the first embodiment of the present disclosure. The User Info field 1300 comprises an AID12 subfield, a RU allocation subfield, a UL FEC Coding subfield, a UL EHT-MCS subfield, a Unallocated/Random Access subfield, an Associated/Unassociated subfield, a PS320 subfield, a RA-RU Information subfield, a UL Target Receive Power subfield and a PS160 subfield, the subfields comprising 12, 8, 1, 4, 1, 1, 1, 4, 7, and 1 bits at bit numbers 0 to 11, 12 to 19, 20, 21 to 24, 25, 26, 27, 28 to 31, 32 to 38 and 39 (denoted as B0 to B11, B12 to B19, B20, B21 to B24, B25, B26, B27, B28 to B31, B32 to B38 and B39) of the User Info field 1300 respectively. The User Info field 1300 may further comprise a Trigger Dependent User Info subfield with a variable number of bits after the PS160 field at B39. The RA-RU Information subfield further comprises a Number of RA-RU field and a More RA-RU field, the fields comprising 3 bits and 1 bit respectively.

The AID12 subfield is set to 2046. The Unallocated/Random Access subfield at B25 (DCM bit for HE STAs or reserved for EHT STAs) further signals whether the User Info field 1300 is unallocated RU or for Random Access. If B25 refers to “Unallocated RU”, all subfields except AID12 and RU Allocation subfields are reserved and the RA-RU is used to signal unallocated RU for EHT/EHT+ STAs as well; whereas if B25 refers to “Random Access”, the format of the User Info field 1300, except the Associated/Unassociated subfield, the PS320 subfield and the RA-RU information subfield, have the same meaning as the fields of the same name in the EHT variant User Info field shown in FIG. 4A. In particular, if B25 refers to “Random Access”, only B28 to B31 (4 bits) are used to signal RA-RU information, while B26 is repurposed as the Associated/Unassociated field to indicate whether the RA-RU is for associated STAs or unassociated STAs, and B27 is repurposed as PS320 field for forward compatibility and is used to indicate whether the allocated RU is located in the primary or secondary 320 MHz frequency segment (PS320 subfield). Even through EHT STAs will not be allocated to the S320, EHT STAs can understand the P320 bit and will not misunderstand RA-RUs allocated in the S320. The format of the solicited TB PPPDU (e.g., HE or EHT) is signaled as explained earlier using the bit combinations shown in Table 1. Table 1 may be expanded in future in similar manner to signal EHT+TB PPDU, e.g. by incorporating the PS320 bit (User Info field B27).

For the User Info field 1300 allocating individually addressed RU to EHT+ STAs, B25, which is currently reserved for EHT STAs, may be used instead to signal PS320. The PS320 field together with the PS160 and the RU Allocation fields are used to signal the RU allocation for EHT+ STAs beyond 320 MHz frequency segment.

According to the first embodiment, the AP ensures that the STAs of different generations transmit TB PPDU in the same PPDU format upon winning UORA contention by intelligent allocation of RA-RUs. For example, RA-RUs allocated within the operating bandwidth of HE STAs solicit an HE TB PPDU, RA-RUs allocated within the portion of the operating bandwidth of EHT STAs that does not overlap with the operating bandwidth of HE STAs solicit an EHT TB PPDU, and RA-RUs allocated within the portion of the operating bandwidth of EHT+ STAs that does not overlap with the operating bandwidth of HE STAs and EHT STAs solicit EHT+TB PPDU.

Non-AP STAs contend for UORA following baseline rules (defined in 802.1 lax) except that STAs of a generation use their own generation's OCWₘᵢₙ, OCWₘₐₓ. Upon winning UORA contention, the non-AP STAs randomly select one of the eligible RA-RUs and transmit TB PPDU in the TB PPDU format mandated by the User Info field corresponding to the selected RA-RU. Here, it is assumed that newer generation STAs are allowed to consider all RA-RUs allocated within their operating bandwidth as eligible RA-RUs.

An advantageous effect of this scheme is that AP can control the UORA parameters for STAs of each generation such that the STAs of different generations have similar probability of winning UORA contention. A drawback of this scheme is that the TB PPDU format is restricted by the location of RA-RU; e.g., if there is even a single associated HE STA in the P160, AP cannot allocate RA-RU that solicits EHT/EHT+TB PPDU in the P160.

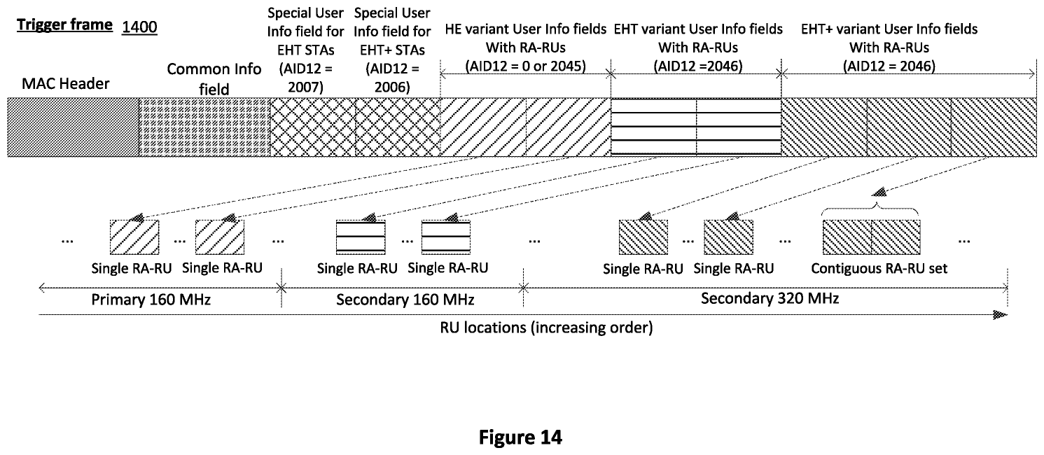

FIG. 14 shows a trigger frame 1400 and its RA-RUs allocation for STAs of different generations according to the first embodiment of the present disclosure. The trigger frame 1400 comprises a MAC Header, a Common Info field, two Special User Info fields with AID12 subfield set to 2007 and 2006 to carry non-derived information that are needed for EHT TB PPDU and EHT+TB PPDU respectively, two HE variant User Info fields allocating two RA-RUs in the primary 160 MHz frequency segment (P160), two EHT variant User Info fields allocating two RA-RUs in the secondary 160 MHz frequency segment (S160) and two EHT+ variant User Info field allocating four RA-RUs in the secondary 320 MHz frequency segment (S320), respectively. The AID12 subfield of the HE variant User Info field is set to 0 or 2045 to allocate RA-RUs to associated or unassociated STAs respectively, while the AID12 subfields of the EHT/EHT+ variant User Info fields are set to 2046 and the Unallocated/Random Access subfields of the EHT/EHT+ variant User Info fields (as shown in FIG. 13) are set to “Random Access”.

For simplicity, only User Info fields relevant for allocating RA-RUs are illustrated. It is possible that the trigger frame may also carry User Info fields allocating individually addressed RUs with AID12 set to specific AIDs or User Info fields used for padding (i.e. AID12=4095).

It is noted that, for the Special User Info field of the trigger frame 1400, a new special AID12 value (e.g. 2006) is used to indicate Special User Info field for EHT+ STAs. The Special User Info field for EHT+ STAs are used to carry the additional values of the fields that are to be copied to the EHT+ preamble fields in the EHT+TB PPDU transmitted by EHT+ STAs and may occur in the trigger frame right after the Common Info field and the Special User Info field for EHT STAs

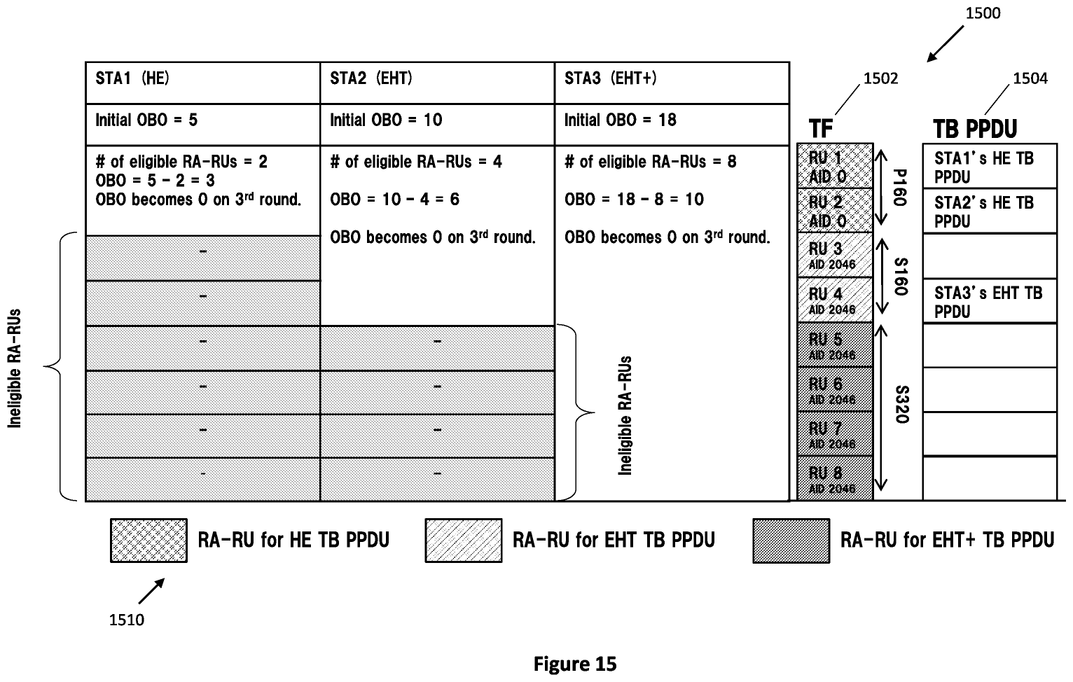

FIG. 15 shows a flow diagram 1500 illustrating a UORA procedure of an HE STA, an EHT STA and an EHT+ STA and a table 1510 illustrating a change in an OBO counter of each STA upon receiving a trigger frame(s) 1502, an allocation of RA-RUs by the trigger frame(s) 1502 and a selection of an RA-RU by each STA for its uplink transmission 1504 according to the first embodiment of the present disclosure. The gray rows under each STA's column in the table 1510 represent RUs that are not eligible for their UORA contention. Only the RUs that align with the rows in white are eligible RA-RUs for the STAs.

It is noted that OBO counter of each STA is randomly selected in the range of 0 to OCWₘᵢₙ. According to the first embodiment, OCWₘᵢₙ and OCWₘₐₓ of the STAs are calculated from respective EOCWₘᵢₙ and EOCWₘₐₓ received from the AP, e.g. through a beacon frame. In this example, the AP advertises an EOCWₘᵢₙ of 3 and an EOCWₘₐₓ of 5 for HE STAs, an EOCWₘᵢₙ of 4 and an EOCWₘₐₓ of 6 for EHT STAs and an EOCWₘᵢₙ of 5 and an EOCWₘₐₓ of 7 for EHT+ STAs. Accordingly, an OCWₘᵢₙ of 7 and an OCWₘₐₓ of 31 is derived by the HE STAs, an OCWₘᵢₙ of 15 and an OCWₘₐₓ of 63 is derived by the EHT STAs, and an OCWₘᵢₙ of 31 and an OCWₘₐₓ of 127 is derived by the EHT+ STA. Before the trigger frame 1502 is sent by the AP, STA1 (HE STA), STA2 (EHT STA) and STA3 (EHT+ STA) have initial OBO values of 5, 10 and 18 respectively.

The trigger frame 1502 may be that of FIG. 14 with User Info fields allocating two RA-RUs (RUs 1 to 2) for HE STAs in the P160, two RA-RUs (RUs 3 to 4) for EHT STAs in the S160 and four RA-RUs (RUs 5 to 8) for EHT+ STA. The User Info fields allocating RA-RUs to EHT/EHT+ STAs have their AID12 subfields set to 2046. As such, HE STAs will ignore such RA-RUs as unallocated RU, while EHT/EHT+ STAs can understand them as RA-RUs. It is also assumed that newer generation STAs are allowed to consider all RA-RUs allocated within their operating bandwidth as eligible RA-RUs. As such, EHT STAs consider RA-RUs allocated in the P320 as eligible RA-RUs while EHT+ STAs consider RA-RUs allocated in the P320 and S320 as eligible RA-RUs.

It is assumed that the trigger frame(s) allocates the same number of RA-RU for each generation of STAs in each round (i.e., two RA-RUs (RU 1, 2) for HE STAs in the P160 (also understood by EHT, EHT+ STAs), four for EHT STAs including the two RA-RUs for HE STAs and another two RA-RUs (RU 3, 4) for EHT STAs in the S160 (also understood by EHT+ STAs), and thus eight for EHT+ STAs including the four for EHT STAs and another four RA-RUs (RU 5, 6, 7, 8)) for EHT+ STAs in the S320).

In the first round, upon receiving the trigger frame 1504, STA1, STA2 and STA3, each having pending frames for the AP, decrement their respective OBO counters by the number of eligible RA-RUs indicated in the Trigger frame (i.e., two RA-RUs for STA1, four RA-RUs for STA2 and eight RA-RUs for STA3). Since OBO counters STA1, STA2 and STA3 all decrements to a nonzero value, it maintains the new OBO values of 3, 6, 10, respectively until it receives a Trigger frame in the second round carrying RA-RUs for the STAs. Similarly, in the second round, upon receiving the trigger frame 1504, STA1, STA2 and STA3, each having pending frames for the AP, decrement their respective OBO counters by the number of eligible RA-RUs indicated in the Trigger frame. Since OBO counters STA1, STA2 and STA3 all decrements to a nonzero value, it maintains the new OBO values of 1, 2, 2, respectively until it receives a Trigger frame in the second round carrying RA-RUs for the STAs.

In the third round, upon receiving the trigger frame 1504, STA1, STA2 and STA3, each having pending frames for the AP, decrement their respective OBO counters by the number of eligible RA-RUs indicated in the Trigger frame. Since the OBO counters of STA1, STA2 and STA3 all decrements to 0 and win the UORA contention in the third round.

STA1, STA2 and STA3 randomly selects one RA-RU from its eligible set of RA-RUs. In this case, STA1, STA2 and STA3 select RU1, RU2 and RU4 and generate an UL TB PPDU according to the format specified in the corresponding User Info fields associated with the RUs. in this case HE TB PPDU, HE TB PPDU and EHT TB PPDU respectively. As a result, STA1, STA2 and STA3 transmit an HE TB PPDU, an HE TB PPDU and an EHT TB PPDU as their uplink signal 1504 in RU1, RU2 and RU4 respectively.

Alternatively, 802.11be spec may define simple rules regarding the choices of PPDU format for the TB PPDUs, e.g., only HE TB PPDU are allowed in RA-RUs that lie in the P160; only EHT TB PPDUs are allowed in RA-RUs that lie in the S160 while EHT+TB PPDUs are only allowed in RA-RUs that lie in the S320.

In the following paragraphs, a second embodiment of the present disclosure is explained with reference to multi-generation random access where a bandwidth unit is advertised to calculate a scaling factor for deriving a contention window for EHT and EHT+ STAs.

According to the second embodiment, instead of advertising different OCW range for STAs of different generation, AP advertises a single OCW range (EOCWₘᵢₙ and EOCWₘₐₓ) for UORA of STAs of different generations, but the OCWₘᵢₙ and OCWₘₐₓ values for an EHT STA and an EHT+ STA are scaled differently depending on the STA's operating bandwidth such that the OCWₘᵢₙ and OCWₘₐₓ values are lower for STAs having a narrower operating bandwidth (e.g. HE STAs) and higher for STAs having a wider operating bandwidth (EHT/EHT+ STAs).

In one example, a scaling factor is calculated using a bandwidth unit (either fixed by the standard or advertised by the AP) and the operating bandwidth of each STA. For example, for HE STAs, OCWₘᵢₙ and OCWₘₐₓ are calculated as per 802.1 lax rules as follows:

$${OCW}_{min} = {2}^{E O C {W}_{min}} - 1 \qquad equation ( 1 )$$

$${O CW}_{max} = {2}^{E O C {W}_{max}} - 1 \qquad equation ( 2 )$$

For EHT/EHT+ STAs, OCWₘᵢₙ and OCWₘₐₓ are scaled based on the STA's operating bandwidth according to the following equations:

$${OCW}_{min} = S . F . \times {2}^{E O C {W}_{min}} - 1 \qquad equation ( 3 )$$

$${OCW}_{max} = S . F . \times {2}^{E O C {W}_{max}} - 1 \qquad equation ( 4 )$$

$$S . F . ( Scaling Factor ) = ceil ( Operating\_Bandwidth / Unit\_Bandwidth ) \qquad equation ( 5 )$$

where Operating_Bandwidth is the STA's operating bandwidth, Unit_Bandwidth may be a value fixed by the standard or a value advertise by the AP and Ceil(x) returns a number rounded up to the next highest integer if x is not an integer.

For example, if Unit_Bandwidth is 80 MHz and an EHT STA's and EHT+ STA's operating bandwidths are 160 MHz and 320 MHz, the scaling factors of the EHT STA and the EHT+ STA is 2 and 4 respectively. In other words, their OCWₘᵢₙ and OCWₘₐₓ could be 2 and 4 times higher than those of an HE STA. Alternatively, it is also possible that for EHT and EHT+ STAs, the Unit_Bandwidth is taken as the operating bandwidth of the BSS for HE STAs (as advertised by the associated AP in Beacon frames in the HE operation element: in the “VHT Operation Information” field for 2.4 GHz and 5 GHz BSS, or in the “6 GHz Operation Information” field for the 6 GHz BSS).

EHT/EHT+ STAs with wider operating bandwidth will contend for UORA with larger values of OCWs and thus their chances of winning the UORA contention will be reduced despite there have a larger number of eligible RA-RUs. Two new AID12 values are defined to indicate RA-RUs for STAs of post HE generations (e.g. EHT/EHT+ STAs). For example, AID values of 2043 and 2044 are used to indicate RA-RU for associated STAs and unassociated STAs respectively.

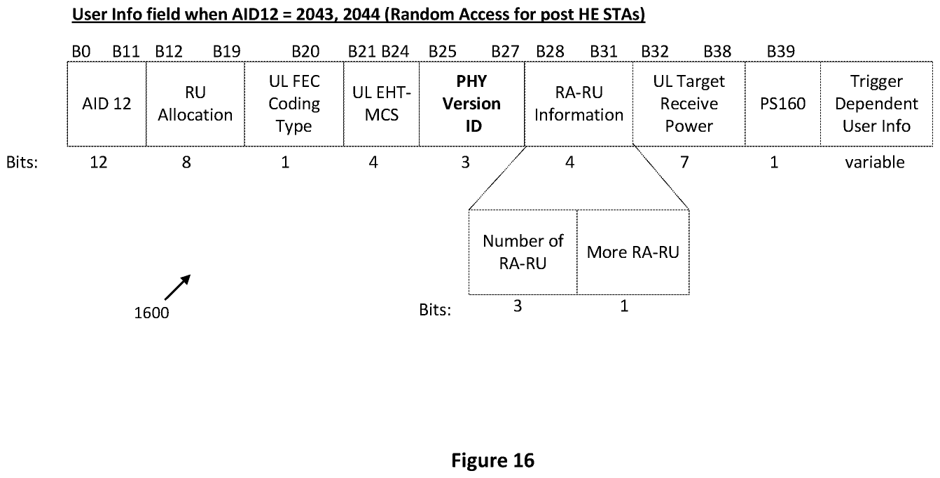

FIG. 16 shows a User Info field 1600 of a trigger frame according to the second embodiment of the present disclosure. The User Info field 1600 comprises an AID12 subfield, a RU allocation subfield, a UL FEC Coding subfield, a UL EHT-MCS subfield, a PHY Version ID subfield, a RA-RU Information subfield, a UL Target Receive Power subfield and a PS160 subfield, the subfields comprising 12, 8, 1, 4, 3, 4, 7, and 1 bits at bit numbers 0 to 11, 12 to 19, 20, 21 to 24, 25 to 27, 28 to 31, 32 to 38 and 39 (denoted as B0 to B11, B12 to B19, B20, B21 to B24, B25 to B27, B28 to B31, B32 to B38 and B39) of the User Info field 1600 respectively. The User Info field 1600 may further comprise a Trigger Dependent User Info subfield with a variable number of bits after the PS160 field at B39. The RA-RU Information subfield further comprises a Number of RA-RU field and a More RA-RU field, the fields comprising 3 bits and 1 bit respectively. All subfields, except the PHY Version ID subfield at B25-27 and the RA-RU Information subfield at B28 to B31 have the same meaning as the fields of the same name in the EHT variant User Info field shown in FIG. 4A. In particular, when AID12 subfield is set to 2043 or 2044, B25 to B27 are used to indicate the PHY version, e.g. a value of 0 to indicate an EHT PHY version, 1 to indicate an EHT+ PHY version and 2-7 reserved for future generations, whereas B28 to B31 (4 bits) are used to signal RA-RU information. STAs will ignore RA-RUs with PHY Version ID that indicates a PHY that is not supported by the STAs. Since HE STAs do not recognize AID12 value of 2043 and 2044 as RA-RUs, they will ignore and not contend for these RA-RUs. Similarly, EHT STAs will only contend for RA-RUs indicated with AID12=0 or 2045, or with AID12=2043, 2044 and with PHY Version ID subfield set to 0 (EHT).

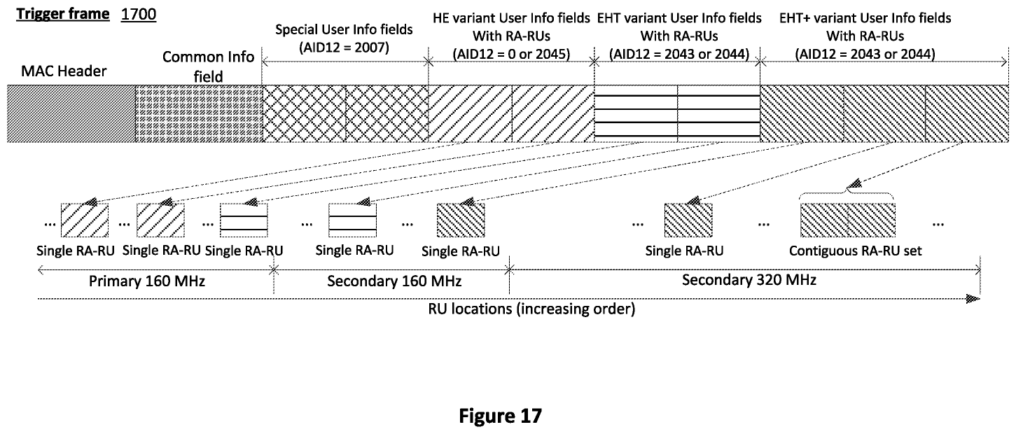

FIG. 17 shows a trigger frame 1700 and its RA-RUs allocation for STAs of different generations according to the second embodiment of the present disclosure. The trigger frame 1700 comprises a MAC Header, a Common Info field, two Special User Info fields with AID12 subfield set to 2007 for EHT/EHT+TB PPDU, two HE variant User Info fields allocating two RA-RUs (hereinafter referred to as “HE variant RA-RUs”) and one EHT variant User Info field allocating one RA-RU (hereinafter referred to as “EHT variant RA-RUs”) in the P160, one EHT variant User Info field and a EHT+ variant User Info field each allocating a RA-RU in the S160 and two EHT+ variant User Info field allocating three RA-RUs (hereinafter referred to as “EHT+ variant RA-RUs”) in the S320 respectively. The AID12 subfield of the HE variant User Info field is set to 0 or 2045 to allocate RA-RUs to associated or unassociated STAs respectively. The AID12 subfield of the EHT and EHT+ variant User Info fields is set to 2043 or 2044. The PHY Version ID of the EHT and EHT+ variant User Info fields is set to 0 and 1 to indicate their respective PHY Versions.

Each variant of User Info field solicits TB PPDU of their own format; e.g. HE variant User Info field solicits HE TB PPDU, EHT variant User Info field solicits EHT TB PPDU and EHT+ variant User Info field solicits EHT+TB PPDU. In this example, the first EHT variant User Info field allocates RA-RU within the P160 while the first EHT+ variant User Info field allocates RA-RU within the S160. Since HE STAs do not understand AID value of 2043 or 2044 as RA-RUs, HE STAs will not contend for these RA-RUs even if they are located within their operating bandwidth (P160). On the other hand, EHT STAs understand AID value 2043 or 2044 but does not recognize PHY Version ID value of 1 in the EHT+ variant User Info field, therefore they will ignore and not contend for the RA-RUs allocated in the EHT+ variant User Info fields even if they are located within their operating bandwidth (S160). Similarly, EHT+ STAs understand AID value 2043 or 2044 but does not recognize PHY Version ID value of 0 in the EHT variant User Info field, therefore they will ignore and not content for the RA-RUs allocated in the EHT variant User Info fields.

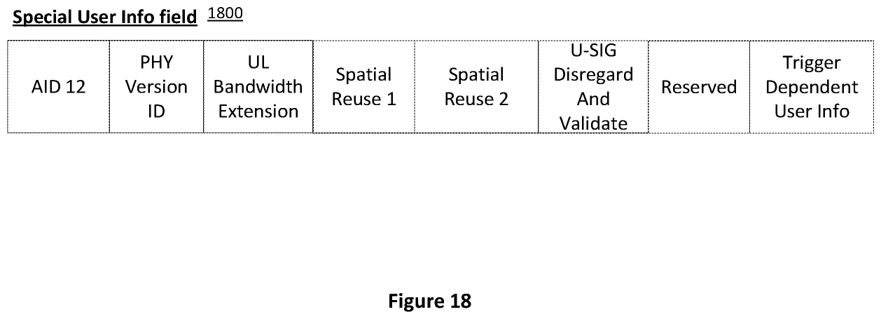

FIG. 18 shows a special User Info field 1800 of the trigger frame 1700 according to the second embodiment of the present disclosure. The Special User Info field comprises an AID12 subfield, a PHY Version ID subfield, a UL Bandwidth Extension subfield, a Spatial Reuse 1 subfield, a Spatial Reuse 2 subfield, a U-SIG Disregard And Validate subfield and a Trigger Dependent User Info subfield. The PHY Version ID subfield indicates the PHY version of TB PPDU the Special User Info field is for, e.g. 0 to indicate EHT TB PPDU and 1 to indicate EHT+TB PPDU.

According to the second embodiment, AP may also advertise a weighing factor to be used by EHT and EHT+ STAs for selection of RA-RUs of different generations for their uplink transmission upon winning UORA contention. The AP may consider factors such as number of associated STAs of each generation to compute the weighing factor with the intention of causing a RA-RU that is eligible for lesser number of STAs to be chosen upon successful UORA contention with a higher probability.

Upon winning UORA contention, non-AP STAs apply the weighing factor to the RA-RUs of different generations when selecting an RA-RU for uplink transmission. With the weighing factor, the UORA contention procedure is modified such that when a STA wins the UORA contention, the random selection of RA-RU for transmission is biased towards selecting an RA-RU that is eligible for lesser number of STAs. Since an AP has a better knowledge of the number of associated STAs of various generations, the AP is in a better position to assign the weightage to be used for the selection of RA-RUs.

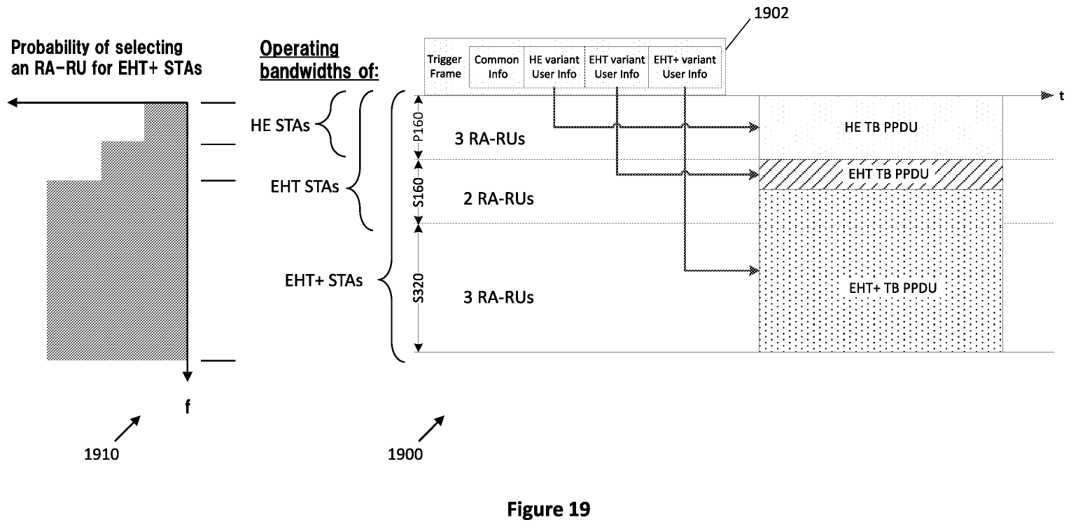

FIG. 19 shows a diagram 1900 illustrating an RA-RUs allocation for HE STAs, EHT STAs and EHT+ STAs by a trigger frame 1902 and a graph 1910 illustrating a probability of selecting each RA-RU from the allocated RA-RUs by an EHT+ STA (left) according to the second embodiment of the present disclosure. The trigger frame 1902 allocates two HE variant RA-RUs (RUs 1 and 2) and one EHT variant RA-RU (RU3) in the P160 soliciting HE TB PPDU and EHT TB PPDU respectively, one EHT variant RA-RU (RU4) and one EHT+ variant RA-RU (RU5) in the S160 and three EHT+ variant RA-RUs (RUs 6 to 8) in the S320 soliciting EHT+TB PPDU. It may be known to the AP that the two HE variant RA-RUs in the P160 are eligible for all HE STAs, EHT STAs and EHT+ STAs (highest number of STAs), the two EHT variant RA-RUs in the P160 and S160 are eligible for both EHT STAs and EHT+ STAs and four EHT+ variant RA-RUs in the S160 and S320 are eligible for EHT+ STAs only (lowest number of STAs), therefore the AP may advertise a weighing factor to be applied to some RA-RUs by EHT+ STAs such that the probability of selecting an HE variant RA-RUs (in the P160) for EHT+ STAs is lower than that of selecting a EHT variant RA-RUs (in the P160 and S160) and the probability of selecting an EHT+ variant RA-RUs (in the S160 and S320) for EHT+ STAs is the highest, as shown in the graph 1910.

For example, for EHT STAs, the AP may assign X₁ and Y₁ as the weighing factors to be used for HE variant RA-RUs and EHT variant RA-RUs respectively, while for EHT+ STAs, the AP may assign X₂, Y₂ and Z as the weighing factors to be used for HE variant RA-RUs, EHT variant RA-RUs and EHT+ variant RA-RUs, respectively. An EHT STA, upon winning UORA contention, chooses an RA-RU randomly from among (X₁×number of HE variant RA-RUs)+(Y₁×number of EHT variant RA-RUs). Similarly, an EHT+ STA, upon winning UORA contention, chooses an RA-RU randomly from among (X₂×number of HE variant RA-RUs)+(Y₂×number of EHT variant RA-RUs)+(Z×number of EHT+ variant RA-RUs).

By customizing the values of the weighing factors, the AP can control the probability distribution of the selection of the RA-RU of each generation and hence attempt to reduce the uneven distribution of collision probability. For example, if the weighing factors of all generations are equal, this is equivalent to baseline UORA i.e., STAs may select RA-RU variant of any generation with equal probability. If the weighing factors for own generation is 1 but the weighing factor for all other generations are 0 (for example in the fourth embodiment of the present disclosure), STAs of each generation will only select the RA-RU variant of their own generation.

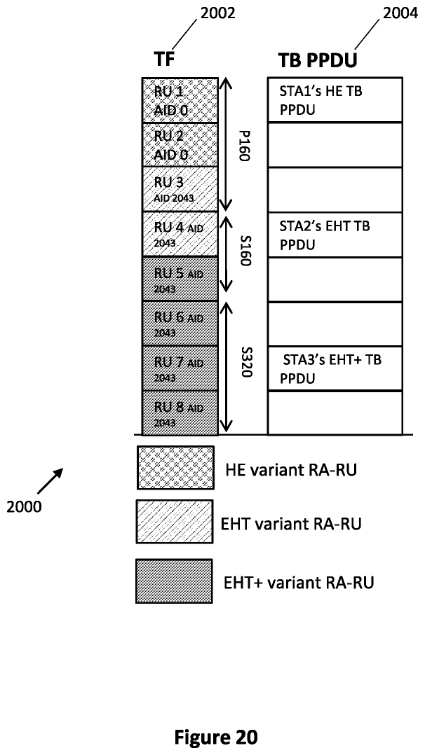

FIG. 20 shows a flow diagram 2000 illustrating an allocation of RA-RUs by a trigger frame 2002 and a selection of an RA-RU by an HE STA, an EHT STA and an EHT+ STA for its uplink signal 2004 according to the second embodiment of the present disclosure. The trigger frame 2002 may be the same as that of FIG. 17. The selection of an RA-RU by the HE STA, the EHT STA and the EHT+ STA is based on the UORA result as described in FIG. 15, that is, STA1, STA2 and STA3 all won the UORA contention in the third round. In contrast to that example described in FIG. 15, during selection of a RA-RU for transmitting their uplink signals 2004, a weighing factor is applied by STA1, STA2 and STA3 to the RA-RUs (RUs 1 to 8) prior to randomly selecting one RA-RU from their respective eligible set of RA-RUs.

In this case, for EHT STAs, the AP assigns X₁ of 1 and Y₁ of 4 as the weighing factors to be used for HE variant RA-RUs and EHT variant RA-RUs respectively, while for EHT+ STAs, the AP assigns X₂ of 1, Y₂ of 1 and Z of 4 as the weighing factors to be used for HE variant RA-RUs, EHT variant RA-RUs and EHT+ variant RA-RUs respectively.

STA1, upon wining UORA contention, randomly selects one RA-RU from its eligible set of RA-RUs. In this case, STA1 select RU1, generate an UL TB PPDU according to the format specified in the corresponding User Info field associated with the RU1, in this case HE TB PPDU, and transmit the HE TB PPDU in RU1.

STA2, upon wining UORA contention, can chooses an RA-RU randomly from among 2 HE variant RA-RUs and 8 EHT variant RA-RUs (RU1, RU2, RU3, RU4, RU3, RU4, RU3, RU4, RU3, RU4). Due to the weighing factors for STA2 (EHT STA), STA2 has 80% probability of choosing an EHT variant RA-RU (RUs 3 and 4) and 20% probability of selecting an HE variant RA-RUs (RUs 1 and 2). As a result, STA2 selects RU4, generate an UL TB PPDU according to the format specified in the corresponding User Info field associated with the RU4, in this case EHT TB PPDU, and transmit the EHT TB PPDU in RU4.

Similarly, STA3, upon wining UORA contention, chooses an RA-RU randomly from among (2 HE variant RA-RUs, 2 EHT variant RA-RUs and 16 EHT+ variant RA-RUs). Due to the weighing factors for STA3 (EHT+ STA), STA3 has 80% probability of choosing an EHT+ variant RA-RU (RUs 5 to 8), 10% probability of selecting an EHT variant RA-RU (RUs 3 and 4) and 10% probability of selecting an HE variant RA-RU (RUs 1 and 2). As a result, STA3 selects RU7, generate an UL TB PPDU according to the format specified in the corresponding User Info field associated with the RU7, in this case EHT+TB PPDU, and transmit an EHT+TB PPDU in RU7.

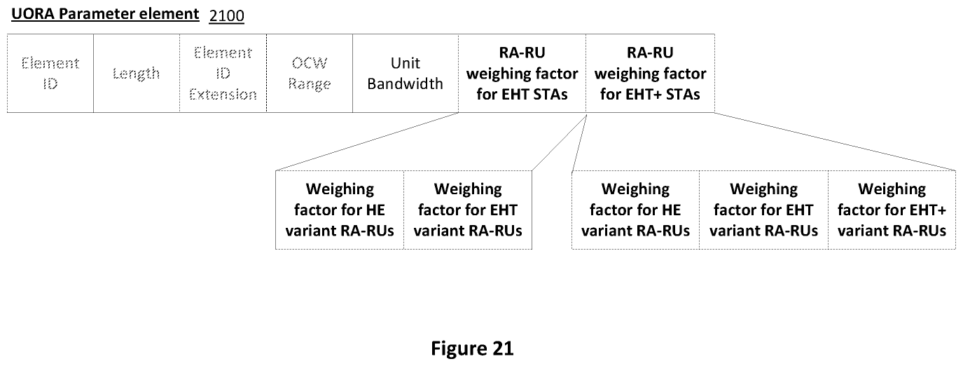

An AP can use a UORA Parameter element to advertise the Unit_Bandwidth and the weighing factor. FIG. 21 shows a UORA Parameter element format 2100 according to the second embodiment of the present disclosure. The UORA Parameter element 2100 comprises an Element ID field, a Length field, an Element ID Extension field, an OCW Range field, a Unit Bandwidth field, a RA-RU weighing factor for EHT STAs field and a RA-RU weighing factor for EHT+ STAs field. The Unit Bandwidth field may be set to a value of 0, 1, 2 and 3 to indicate a bandwidth unit of 20 MHz, 80 MHz, 160 MHz and 320 MHz respectively, while a value of 4 to 255 is reserved for future purposes.

Advantageously, with bandwidth unit and scaling factor, STAs have similar probability of winning UORA contention regardless of their operating bandwidth (or generation) while APs have flexibility of allocating RA-RUs for different TB PPDU format in different positions within the BSS bandwidth. At the same time, APs can also control the collision probability for RA-RUs of various generation using weighing factors.

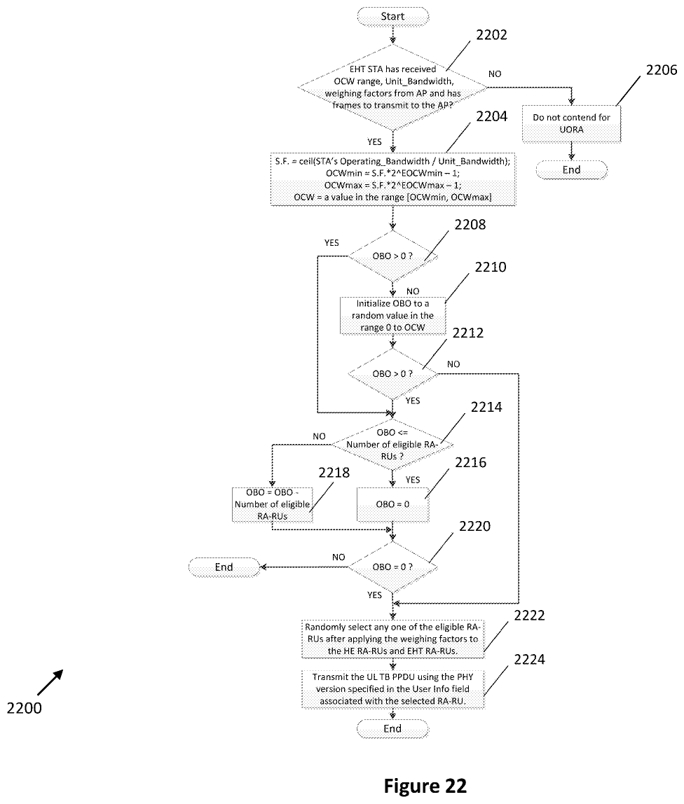

FIG. 22 shows a flow chart 2200 illustrating a UORA procedure carried out by an EHT STA according to the second embodiment of the present disclosure. In step 2202, a step of determining if the EHT STA has received a OCW range, a Unit_Bandwidth and a weighing factor from an AP, and the EHT STA has frames to transmit to the AP are carried out. If so, step 2204 is carried out, otherwise step 2206 is carried out where the EHT STA does not content for UORA. In step 2204, a scaling factor for the EHT STA is calculated based on its operating bandwidth and the Unit_Bandwidth, and then a contention window of the EHT STA, i.e.

OCWₘᵢₙ and OCWₘₐₓ, is calculated based on the scaling factor and the OCW range. The EHT STA may also select an OCW value in the range of the calculated OCWₘᵢₙ and OCWₘₐₓ. In step 2208, a step of determining if OBO counter is larger than 0. If the OBO counter is larger than 0, the process is skipped to step 2214; otherwise step 2210 is carried out. In step 2210, a step of initializing the OBO counter to a random value in the range between 0 to OCW is carried out. In step 2212, it is then again determined if the OBO counter is larger than 0. If the OBO counter is larger than 0, step 2214 is carried out; otherwise step 2222 is carried out. In step 2214, it is determined if the value of OBO counter is lower than the number of RA-RUs eligible for the EHT STA. If so, the OBO counter is set to a value of 0 in step 2216; otherwise, step 2218 is carried out. In step 2218, the OBO counter is decremented by the number of eligible RA-RUs. In step 2220, it is determined if the value of OBO counter is 0. If the OBO counter is 0, step 2222 is carried out; otherwise, the process may end. In step 2222, a step of randomly selecting any one RA-RUs of the eligible RA-RUs after applying weighing factors to the HE RA-RUs and EHT RA-RUs is carried out. In step 2224, a step of transmitting an UL TB PPDU using the PHY version specified in the User Info field associated with the selected RA-RU, and the process may end.

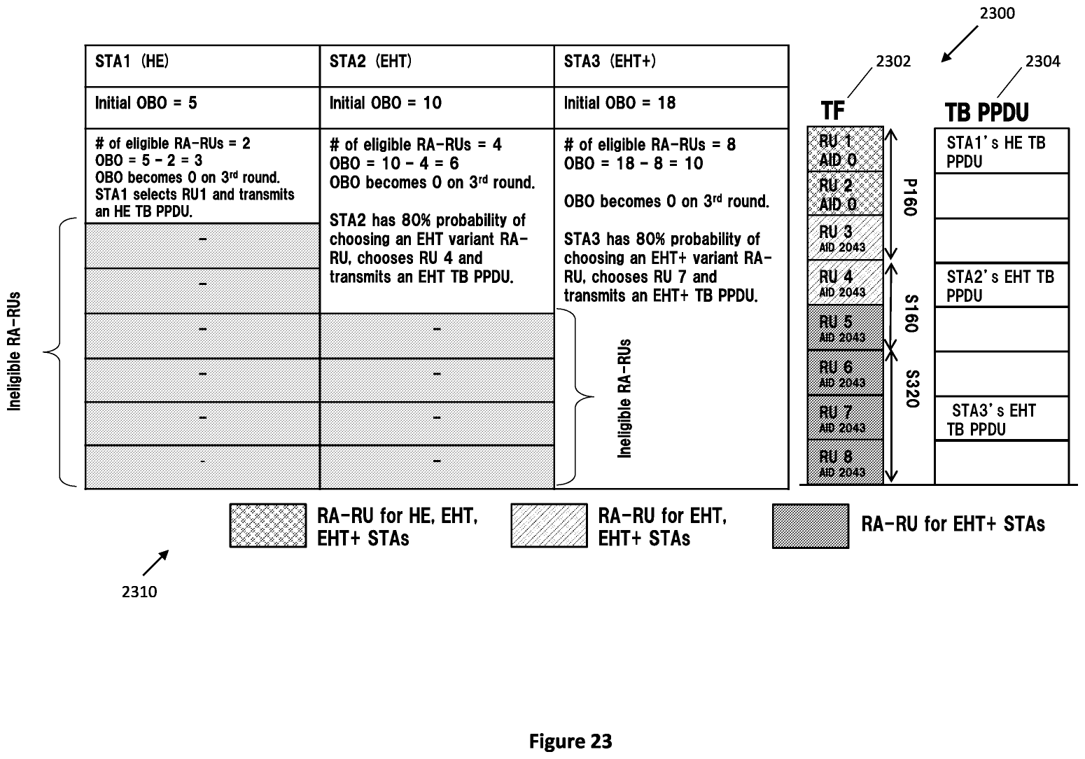

FIG. 23 shows a flow diagram 2300 illustrating a UORA procedure of an HE STA, an EHT STA and an EHT+ STA and a table 2310 illustrating a change in an OBO counter of each STA upon receiving a trigger frame(s) 2302, an allocation of RA-RUs by the trigger frame(s) 2302 and a selection of an RA-RU by each STA for its uplink signal 2304 according to the second embodiment of the present disclosure. The gray rows under each STA's column in the table 2310 represent RUs that are not eligible for their UORA contention. Only the RUs that align with the rows in white are eligible RA-RUs for the STAs. In this example, the AP advertises, e.g. through a beacon frame, a bandwidth unit of 160 MHz (Unit_Bandwidth=160 or Unit_Bandwidth subfield set to 2), single OCW range of 3 to 5 (EOCWₘᵢₙ=3 and EOCWₘₐₓ=5), weighing factors for HE variant RA-RUs of 1 (X₁=1) and EHT variant RA-RUs of 4 (Y₁=4) for EHT STAs respectively and weighing factors for HE variant RA-RUs of 1 (X₂=1), EHT variant RA-RUs of 1 (Y₂=1) and EHT+ variant RA-RUs of 4 (Z=4) for EHT+ STAs respectively.

As a result, based on the bandwidth unit and the operating bandwidths of EHT STAs and EHT STAs according to equation (5), scaling factors for EHT STAs and EHT+ STAs of 2 and 4 can be calculated respectively. The OCWₘᵢₙ and OCWₘₐₓ of HE STAs, EHT STAs and EHT+ STAs can be further calculated based on the single EOCWₘᵢₙ and EOCWₘₐₓ and the scaling factors. Accordingly, an OCWₘᵢₙ of 7 and an OCWₘₐₓ of 31 is derived by the HE STAs, an OCWₘᵢₙ of 15 and an OCWₘₐₓ of 63 is derived by the EHT STAs by applying the scaling factor of 2, and an OCWₘᵢₙ of 31 and an OCWₘₐₓ of 127 is derived by the EHT+ STA by applying the scaling factor of 4. Before the trigger frame 2302 is sent by the AP, STA1 (HE STA), STA2 (EHT STA) and STA3 (EHT+ STA) have initial OBO values of 5, 10 and 18 respectively.

The trigger frame 2302 may be that of FIG. 17 with User Info fields allocating two HE variant RA-RUs (RUs 1 to 2) and one EHT variant RA-RUs (RU 3) in the P160, one EHT variant RA-RU (RU4) and one EHT+ variant RA-RU (RU5) in the S160 and three EHT+ variant RA-RUs (RUs 6 to 8) in the S320. The AID12 subfield of the HE variant User Info field is set to 0 to allocate RA-RUs to associated STAs, while the AID12 subfield of the EHT and EHT+ variant User Info fields is set to 2043. The PHY Version ID of the EHT variant User Info fields is set to 0 and the PHY Version ID EHT+ variant User Info fields is set to 1.

It is again assumed that the trigger frame(s) allocates the same number of RA-RU for each generation of STAs in each round (i.e., two RA-RUs (RU 1, 2) for HE STAs in the P160 (also understood by EHT, EHT+ STAs), four for EHT STAs including the two RA-RUs for HE STAs and another two RA-RUs (RU 3, 4) for EHT STAs in the P160 and S160 (also understood by EHT+ STAs), and thus eight for EHT+ STAs including the four for EHT STAs and another four RA-RUs (RU 5, 6, 7, 8)) for EHT+ STAs in the S160 and S320). Before the trigger frame 2302 is sent by the AP, STA1 (HE STA), STA2 (EHT STA) and STA3 (EHT+ STA) have initial OBO values of 5, 10 and 18 respectively.

In the first round, upon receiving the trigger frame 2302, STA1, STA2 and STA3, each having pending frames for the AP, decrement their respective OBO counters by the number of eligible RA-RUs indicated in the Trigger frame (i.e., two RA-RUs for STA1, four RA-RUs for STA2 and eight RA-RUs for STA3). Since OBO counters STA1, STA2 and STA3 all decrements to a nonzero value, it maintains the new OBO values of 3, 6, 10, respectively until it receives a Trigger frame in the second round carrying RA-RUs for the STAs. Similarly, in the second round, upon receiving the trigger frame 2302, STA1, STA2 and STA3, each having pending frames for the AP, decrement their respective OBO counters by the number of eligible RA-RUs indicated in the Trigger frame. Since OBO counters STA1, STA2 and STA3 all decrements to a nonzero value, it maintains the new OBO values of 1, 2, 2, respectively until it receives a Trigger frame in the second round carrying RA-RUs for the STAs.

In the third round, upon receiving the trigger frame 2302, STA1, STA2 and STA3, each having pending frames for the AP, decrement their respective OBO counters by the number of eligible RA-RUs indicated in the Trigger frame. The OBO counters of STA1, STA2 and STA3 all decrements to 0 and STA1, STA2 and STA3 win the UORA contention in the third round.

STA1, upon wining UORA contention, randomly selects one RA-RU from its eligible set of RA-RUs. In this case, STA1 select RU1, generates an UL TB PPDU according to the format specified in the corresponding User Info field associated with the RU1, in this case HE TB PPDU, and transmit an HE TB PPDU in RU1.

Due to the weighing factors for STA2 (EHT STA), STA2 has 80% probability of choosing an EHT variant RA-RU (RUs 3 and 4). As a result, upon wining UORA contention, STA2 selects RU4, generate an UL TB PPDU according to the format specified in the corresponding User Info field associated with the RU4, in this case EHT TB PPDU, and transmit an EHT TB PPDU in RU4.

Similarly, due to the weighing factors for STA3 (EHT+ STA), STA3 has 80% probability of choosing an EHT+ variant RA-RU (RUs 5 to 8). As a result, upon wining UORA contention, STA3 selects RU7, generate an UL TB PPDU according to the format specified in the corresponding User Info field associated with the RU7, in this case EHT+TB PPDU, and transmit an EHT+TB PPDU in RU7

Alternatively, 802.11be spec may define simple rules regarding the choices of PPDU format for the TB PPDUs, e.g., only HE TB PPDU are allowed in RA-RUs that lie in the P160; only EHT TB PPDUs are allowed in RA-RUs that lie in the S160 while EHT+TB PPDUs are only allowed in RA-RUs that lie in the S320.

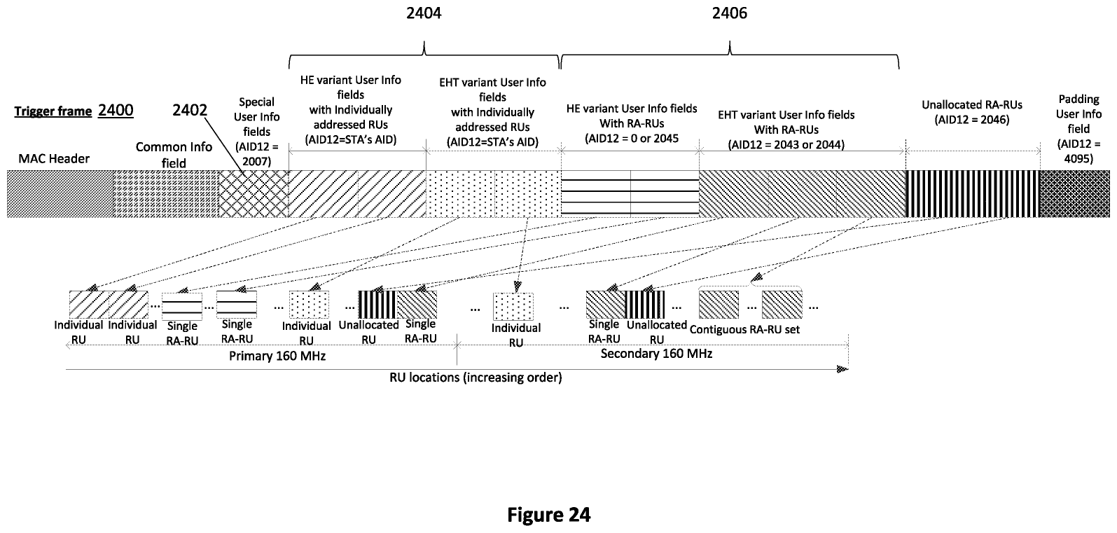

FIG. 24 shows a trigger frame 2400 and an allocation of individually addressed RU(s) and RA-RU(s) for STAs of different generations according to the second embodiment of the present disclosure. The trigger frame 2400 and its RA-RUs allocations are similar to those of the trigger frame 1700 in FIG. 17 but further comprising different variant User Info fields 2404 (e.g. HE/EHT variant User Info fields) allocating individually addressed RUs placed in any order between the Special User Info field 2402 and a User Info fields 2406 allocating RA-RUs (e.g., with AID12 set to 0 or 2045 or 2046). The AID12 subfields of such User Info fields 2404 are set to the STA's AID to which the RUs are individually addressed by the AP respectively.

It is noted that even in such mixed signaling of individually addressed RU and RA-RUs, the Special User Info field is placed immediately after the Common Info field. Different variant User Info fields allocating RA-RUs 2406 may be placed after the User Info fields of different variants allocating individually addressed RUs 2404. The trigger frame may further comprise a signal field after the User Info fields allocating RA-RUs 2406 to signal one or more unallocated RA-RUs (e.g. User Info field with AID12 set to 2046) and ends with zero or more Padding User Info fields.

In the following paragraphs, a third embodiment of the present disclosure is explained with reference to multi-generation random access where a modified UORA contention procedure for EHT/EHT+ STAs is proposed.

According to the third embodiment, AP advertises a single OCW range for UORA. For the newer generations STAs (e.g. EHT/EHT+ STAs), the number of OBOs to be decremented during each UORA contention is equal to the maximum RA-RUs allocated for HE STAs (i.e., HE variant RA-RUs) instead of the number of eligible RA-RUs for the newer generations STAs. This ensures that the UORA contention is slower for the newer generations STAs and the probability of winning UORA contention for STAs of all generations will be the same.

In the modified UORA contention procedure for EHT/EHT+ STAs, an EHT/EHT+ STA that has a pending frame for the AP, upon the reception of a Trigger frame containing at least one eligible RA-RU, if the OBO counter of the EHT/EHT+ STA is not greater than the number of HE variant RA-RUs in a Trigger frame from that AP, then the EHT/EHT+ STA shall set its OBO counter to zero and randomly select one of the eligible RA-RUs to be considered for transmission. Otherwise, the EHT/EHT+ STA decrements its OBO counter by the number of HE variant RA-RUs allocated in the Trigger frame. Upon winning UORA contention, an STA may select any eligible RA-RU for transmission (baseline UORA rule).

A User Info field with the AID12 subfield set to 0 or 2045 is used to allocate RA-RUs to associated and unassociated non-AP STAs respectively regardless of their generation (HE/EHT/EHT+ etc.). A special AID12 value (e.g. 4095 used to signal Padding field for HE STAs) is used to separate the RA-RUs for STAs of different generation. HE STAs are expected to discard all User Info fields that occur after the Padding field, but EHT and EHT+ STA will continue to parse such User Info fields.

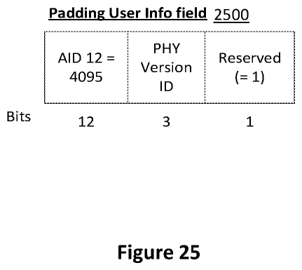

FIG. 25 shows an example Padding User Info field 2500 of a trigger frame according to a third embodiment of the present disclosure. The Padding User Info field 2500 comprises a AID12 subfield set to 4095 and a PHY Version ID subfield, the subfields comprising 12 bits and 3 bits respectively. The Padding field (a User Info field with AID12 subfield set to 4095) is at least 2 octets long. It is set to all ones for HE STAs. For EHT/EHT+ STAs, the format of the Padding field is defined in Table 2. According to various embodiments of the present disclosure A Padding field may also be called HE variant Padding field, EHT variant Padding field, EHT+ variant Padding field etc. based on the PHY Version ID subfield. Alternatively, new special AID 12 values (e.g. 4094, 4093 etc.) may be defined to represent Padding fields for EHT, EHT+ STAs respectively.

TABLE 2
Various PHY Version ID values and their meanings for stations of different generations

| PHY Version | | | |
|---|---|---|---|
| ID | Meaning for HE STAs | Meaning for EHT STAs | Meaning for EHT + STAs |
| 7 | Start of Padding | Start of RA-RUs for EHT | Start of RA-RUs for EHT |
| | Discard rest of the TF | STAs | STAs |
| 0 | Undefined | Start of Padding | Start of RA-RUs for EHT+ |
| | | Discard rest of the TF | STAs |
| 1 | Undefined | Undefined | Start of Padding |
| | | | Discard rest of the TF |

| | |
|---|---|
| 2-6 | Reserved |

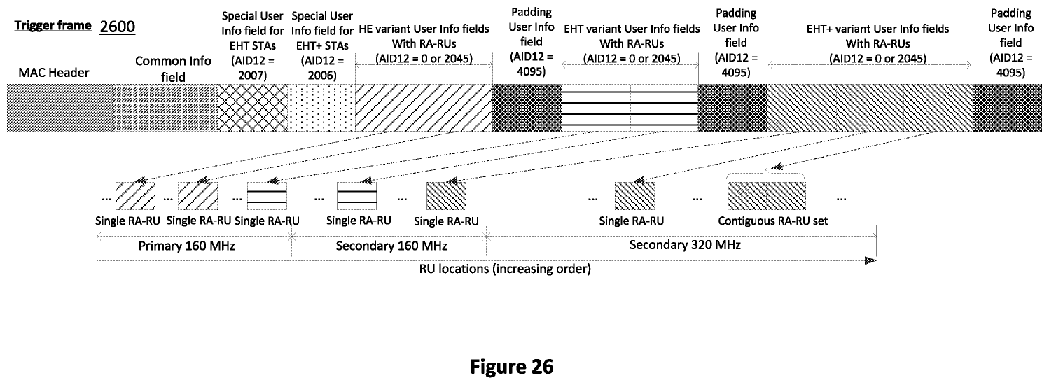

FIG. 26 shows a trigger frame 2600 and its RA-RUs allocation for STAs of different generations according to the third embodiment of the present disclosure. The trigger frame 2600 comprises a MAC Header, a Common Info field, two Special User Info fields with AID12 subfield set to 2007 and 2006 for EHT STAs and EHT+ STAs respectively, two HE variant User Info fields allocating two RA-RUs and one EHT variant User Info field allocating one RA-RU in the P160, one EHT variant User Info field and a EHT+ variant User Info field each allocating a RA-RU in the S160 and two EHT+ variant User Info field allocating three RA-RUs in the S320 respectively.

Instead of using the PHY ID field, a new special AID12 value (e.g. 2006) is used to indicate Special User Info field for EHT+ STAs. The Special User Infor field for EHT+ STAs are used to carry the additional values of the fields that are to be copied to the EHT+ preamble fields in the EHT+TB PPDU transmitted by EHT+ STAs.

The AID12 subfield of the HE/EHT/EHT+ variant User Info field is set to 0 or 2045 to allocate RA-RUs to associated or unassociated STAs respectively. The trigger frame 2600 further comprises a Padding User Info field with AID12 subfield set to 4095 after each different variant User Info field that allocates RA-RUs. In particular, the trigger frame 2600 comprises an HE Padding User Info field with values set to all one after HE variant User Info fields that allocate RA-RUs to separate the fields from the following EHT variant User Info fields that allocate RA-RUs, a EHT Padding User Info field with PHY Version ID subfield set to 0 after the EHT variant User Info fields that allocate RA-RUs to separate the fields from the following EHT+ variant User Info fields that allocate RA-RUs and a EHT+ Padding User Info fields with PHY Version ID subfield set to 1 after EHT+ variant User Info fields to signal padding for EHT+ STAs. The AP is required to ensure the Padding fields for different generations occur in the trigger frame 2600 is in the following order: HE variant followed by EHT variant followed by EHT+ variant etc.

STAs of all generations are able to identify the same number of HE RA-RUs with the use of HE Padding field. In this third embodiment of the present disclosure, as the OCW range and the number of OBOs to be decremented for STAs of all generations during each UORA contention is equal to the maximum RA-RUs allocated for HE STAs, STAs have exactly the same probability of winning UORA contention.

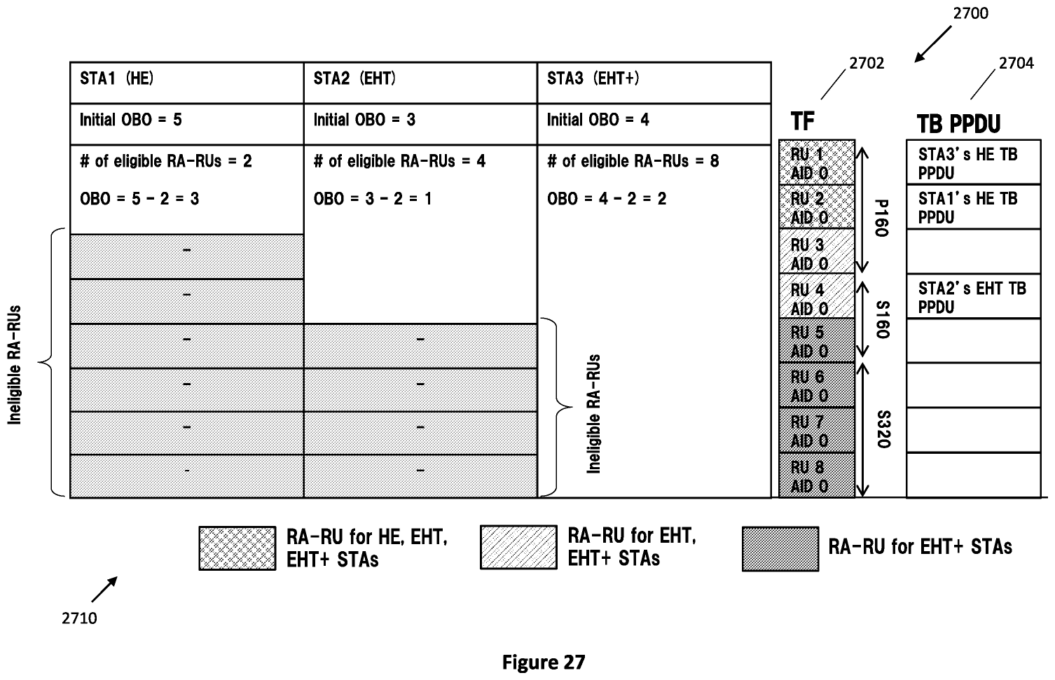

FIG. 27 shows a flow diagram 2700 illustrating a UORA procedure of an HE STA, an EHT STA and an EHT+ STA and a table 2710 illustrating a change in an OBO counter of each STA upon receiving a trigger frame(s) 2702, an allocation of RA-RUs by the trigger frame(s) 2702 and a selection of an RA-RU by each STA for its uplink signal 2704 according to the third embodiment of the present disclosure. The gray rows under each STA's column in the table 2710 represent RUs that are not eligible for their UORA contention. Only the RUs that align with the rows in white are eligible RA-RUs for the STAs. The trigger frame 2702 comprises User Info fields allocating two HE variant RA-RUs (RUs 1 to 2) and one EHT variant RA-RUs (RU 3) in the P160, one EHT variant RA-RU (RU4) and one EHT+ variant RA-RU (RU5) in the S160 and three EHT+ variant RA-RUs (RUs 6 to 8) in the S320. The AID12 subfields of the HE/EHT/EHT+ variant User Info fields are set to 0 to allocate RA-RUs to associated STAs. The trigger frame 2702 further comprises a Padding User Info field between User Info fields allocating RA-RUs for different generations. Before the trigger frame 2702 is sent by the AP, STA1 (HE STA), STA2 (EHT STA) and STA3 (EHT+ STA) have initial OBO values of 5, 3 and 4 respectively. STA1, STA2 and STA3 each has pending frames for the AP,

In every round, upon receiving a trigger frame 2702, STA1, STA2 and STA3 decrement their respective OBO counters by the number of RA-RUs allocated for HE STAs in the trigger frame (i.e., two RA-RUs). As a result, STA1, STA2 and STA3 will have their OBO counters decremented to a zero value at the third round, second round and second round respectively.

STA1, upon wining UORA contention at the third round, randomly selects one RA-RU from its eligible set of RA-RUs (RUs 1 and 2). In this case, STA1 select RU2, generate an UL TB PPDU according to the format specified in the corresponding User Info field associated with the RU2, in this case HE TB PPDU, and transmit an HE TB PPDU in RU2.

STA2, upon wining UORA contention at the second round, randomly selects one RA-RU from its eligible set of RA-RUs (RUs 1 to 4). In this case, STA2 select RU4, generate an UL TB PPDU according to the format specified in the corresponding User Info field associated with the RU4, in this case EHT TB PPDU, and transmit an EHT TB PPDU in RU4.

STA3, upon winning UORA contention at the second round, randomly selects one RA-RU from its eligible set of RA-RUs (RUs 1 to 8). In this case, STA3 select RU1, generate an UL TB PPDU according to the format specified in the corresponding User Info field associated with the RU1, in this case HE TB PPDU, and transmit an HE TB PPDU in RU1.

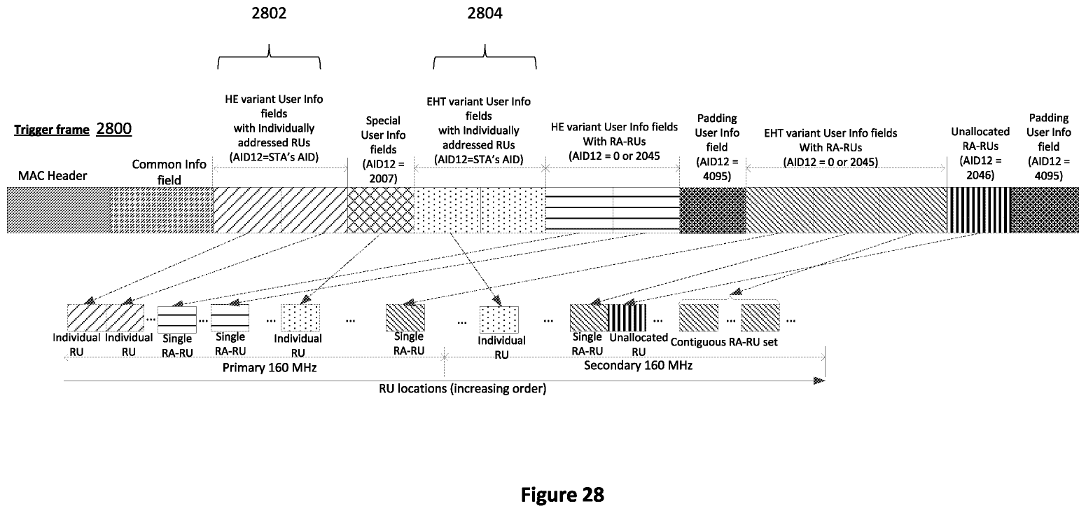

FIG. 28 shows a trigger frame 2800 and an allocation of individually addressed RU(s) and RA-RU(s) for STAs of different generations according to the third embodiment of the present disclosure. The trigger frame 2800 and its RA-RUs allocations are similar to those of the trigger frame 2800 in FIG. 26 but further comprising different variant User Info fields 2802, 2804 (e.g. HE/EHT variant User Info fields) allocating individually addressed RUs. The HE variant User Info field may be placed immediately after a Common Info field while a Special User Info field may be placed after the HE Variant User Info fields and followed by the EHT variant User Info fields 2804. The AID12 subfields of such User Info fields 2802, 2804 are set to the STA's AID to which the RUs are individually addressed by the AP respectively.

HE STAs are expected to discard all user info fields that occur after the first Padding field, while EHT STAs will continue to decode the following EHT variant User Info fields. Different variant User Info fields allocating RA-RUs 2406 may be placed after the User Info fields allocating individually addressed RUs 2404. The trigger frame may further comprise a signal field after the User Info fields allocating RA-RUs 2406 to signal one or more unallocated RA-RUs and ends with zero or more Padding User Info fields for EHT STAs.

The trigger frame 2800 further comprises an HE Padding User Info field with values set to all one after HE variant User Info fields that allocate RA-RUs to separate the fields from the following EHT variant User Info fields that allocate RA-RUs. The trigger frame 2800 further comprises a signal field after the EHT variant User Info fields to signal one or more unallocated RA-RUs and ends with its EHT Padding User Info field.

In the following paragraphs, a fourth embodiment of the present disclosure is explained with reference to multi-generation random access where different RA-RUs are allocated to STAs of different generations.

According to the fourth embodiment, an AP allocates different RA-RUs for different generations, e.g., by defining different AID12 values to indicate RA-RUs for different generations. E.g., AID 2044 for associated EHT STAs, AID 2043 for unassociated EHT STAs, AID 2042 for associated EHT+ STAs, AID 2041 for unassociated EHT+ STAs etc. Alternatively, similar effect can be achieved using the second embodiment where the AP advertises a weighing factor of 1 for RA-RUs of a STA's own generation but the weighing factor of 0 for RA-RUs of all other generations (e.g. for EHT STAs, weighing factor for HE variant RA-RUs is 0 and weighing factor for EHT variant RA-RUs is 1) such that STAs of each generation will only select the RA-RU variant of their own generation.

A non-AP STA only considers an RA-RU allocated for its own generation as eligible RA-RU during the UORA contention and subsequent transmission. Although a non-AP STAs of a newer generation can understand the RA-RU allocated for older generation, it is not allowed to contend/transmit on these RA-RUs using UORA.

Such UORA can be termed as UORA for different generations, i.e. HE UORA, EHT UORA, EHT+ UORA etc. AP may advertise the same EOCWₘᵢₙ and EOCWₘₐₓ application for STAs of all generations. Alternatively, AP may advertise different EOCWₘᵢₙ, EOCWₘₐₓ for different generations such as that described in the first embodiment. In such case, the AP can customize UORA for STAs of each generation without affecting UORA for other generations. Advantageously, the collisions during UORA contention are limited to the RA-RUs allocated for each generation. This addresses the issue of uneven distribution of collision probability.

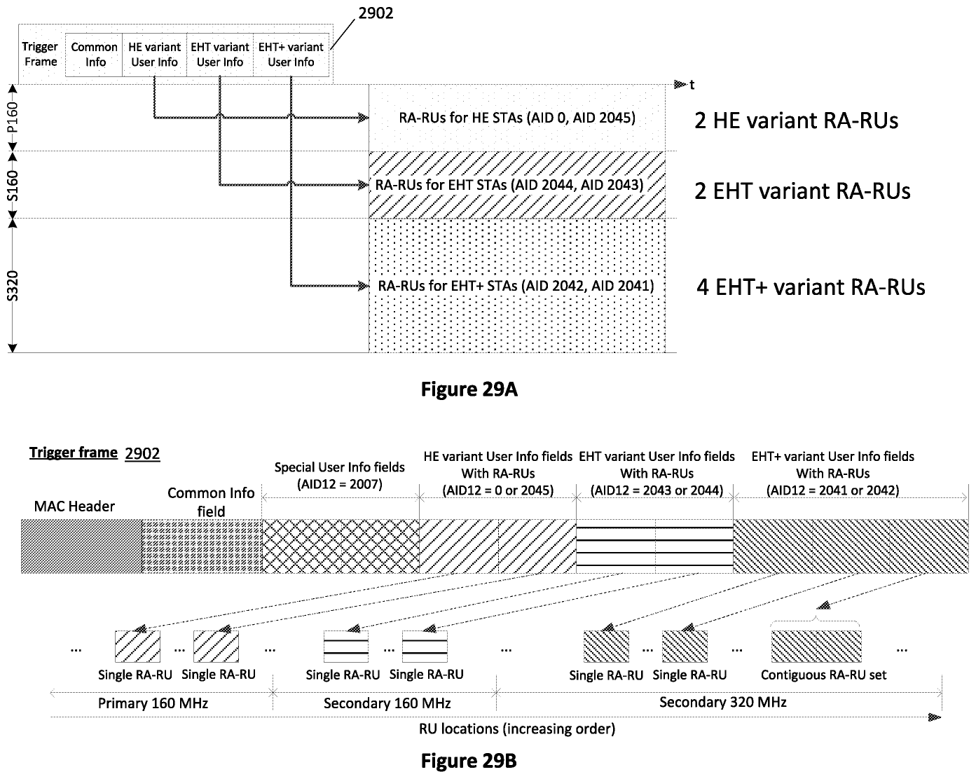

FIGS. 29A and 29B show an RA-RUs allocation for HE STAs, EHT STAs and EHT+ STAs by a trigger frame 2902 according to a fourth embodiment of the present disclosure. The trigger frame 2902 comprises User Info fields allocating two HE variant RA-RUs in the P160 soliciting HE TB PPDU, two EHT variant RA-RUs in the S160 soliciting an EHT TB PPDU, and four EHT+ variant RA-RUs in the S320 soliciting EHT+TB PPDU. The AID subfields of the User Info fields allocating different variant RA-RUs are different, namely the AID subfields of HE variant User Info fields are either 0 or 2045, of EHT variant User Info fields are either 2043 or 2044 and or EHT+ variant User Info fields are either 2041 or 2042.

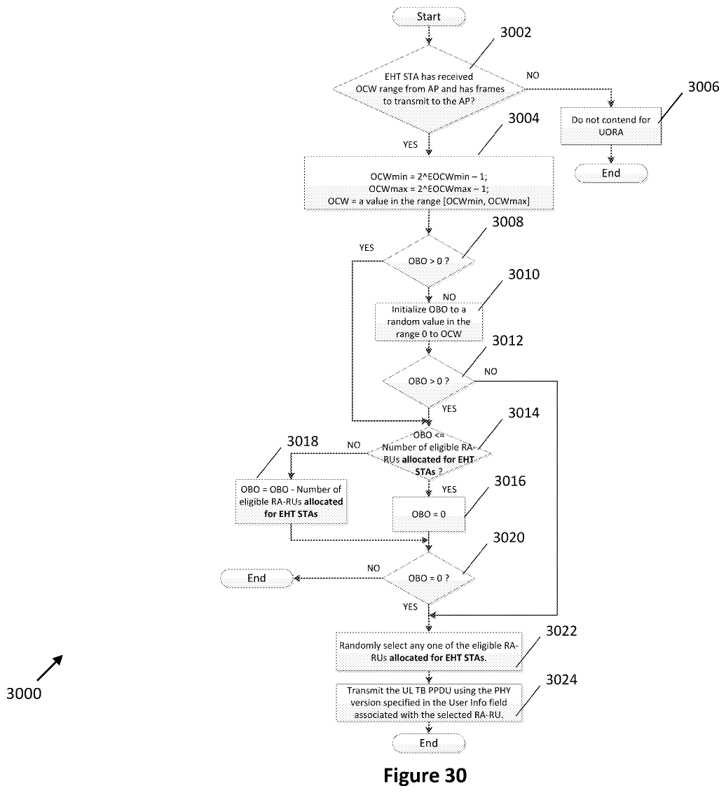

FIG. 30 shows a flow chart 3000 illustrating a UORA procedure carried out by an EHT STA according to the fourth embodiment of the present disclosure. In step 3002, a step of determining if the EHT STA has received a OCW range from an AP, and the EHT STA has frames to transmit to the AP are carried out. If so, step 3004 is carried out, otherwise step 3006 is carried out where the EHT STA does not content for UORA. In step 3004, a contention window of the EHT STA, i.e. OCWₘᵢₙ and OCWₘₐₓ, is calculated based on the OCW range. The EHT STA may also select an OCW value in the range of the calculated OCWₘᵢₙ and OCWₘₐₓ. In step 3008, a step of determining if OBO counter is larger than 0. If the OBO counter is larger than 0, the process is skipped to step 3014; otherwise step 3010 is carried out. In step 3010, a step of initializing the OBO counter to a random value in the range between 0 to OCW is carried out. In step 3012, it is then again determined if the OBO counter is larger than 0. If the OBO counter is larger than 0, step 3014 is carried out; otherwise step 3022 is carried out. In step 3014, it is determined if the value of OBO counter is lower than the number of RA-RUs allocated for EHT STAs. If so, the OBO counter is set to a value of 0 in step 3016; otherwise, step 3018 is carried out. In step 3018, the OBO counter is decremented by the number of RA-RUs allocated for EHT STAs. In step 3020, it is determined if the value of OBO counter is 0. If the OBO counter is 0, step 3022 is carried out; otherwise, the process may end. In step 3022, a step of randomly selecting any one RA-RUs of RA-RUs allocated for EHT STAs is carried out. In step 3024, a step of transmitting an UL TB PPDU using the PHY version specified in the User Info field associated with the selected RA-RU, and the process may end.

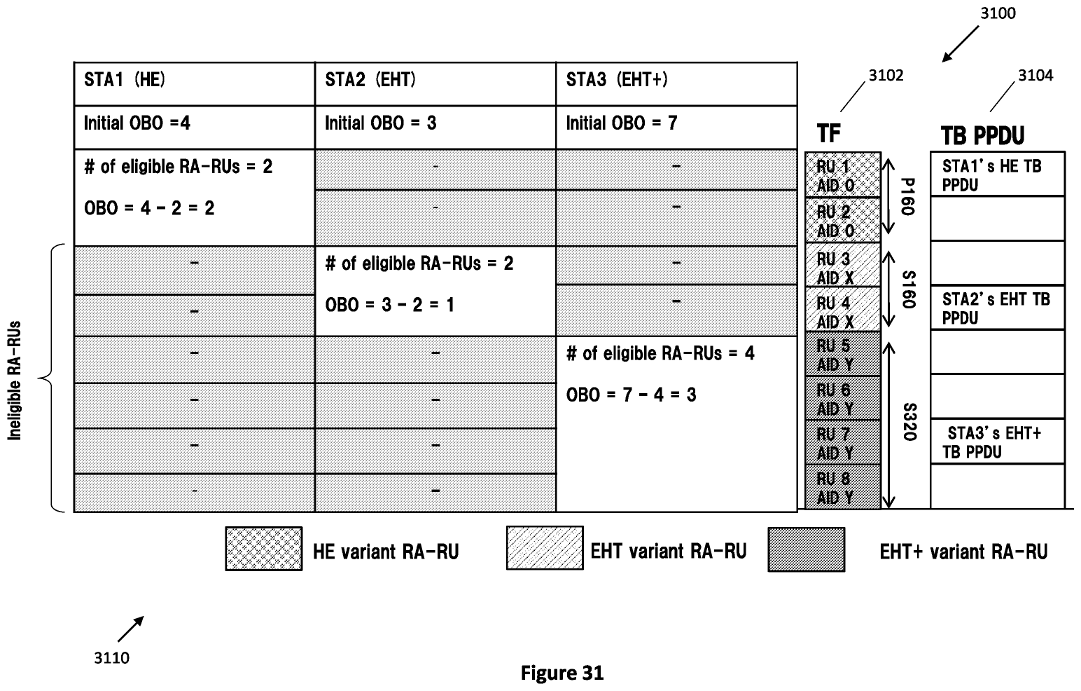

FIG. 31 shows a flow diagram 3100 illustrating a UORA procedure of an HE STA, an EHT STA and an EHT+ STA and a table 3110 illustrating a change in an OBO counter of each STA upon receiving a trigger frame(s) 3102, an allocation of RA-RUs by the trigger frame(s) 3102 and a selection of an RA-RU by each STA for its uplink signal 3104 according to the fourth embodiment of the present disclosure. The gray rows under each STA's column in the table 3110 represent RUs that are not eligible for their UORA contention. Only the RUs that align with the rows in white are eligible RA-RUs for the STAs. The trigger frame 3102 comprises User Info fields allocating two RA-RUs (RUs 1 to 2) for HE STAs in the P160, two RA-RUs (RUs 3 and 4) for EHT STAs in the S160 and four RA-RUs (RUs 5 to 8) in the S320. The AID subfields of the User Info fields allocating the RA-RUs for STAs of different generation are set differently, i.e. AID12 subfields of HE variant User Info fields, EHT variant User Info fields and EHT+ User Info fields are set to 0, X and Y such that HE STAs only consider RU1 and RU2 as eligible RA-RUs, EHT STAs only consider RU3 and RU4 as eligible RA-RUs; whereas EHT+ STAs only consider RU5 to RU8 as eligible RA-RUs.

Before the trigger frame 3102 is sent by the AP, STA1 (HE STA), STA2 (EHT STA) and STA3 (EHT+ STA) have initial OBO values of 4, 3 and 7 respectively. STA1, STA2 and STA3 each has pending frames for the AP.

In every round, upon receiving a trigger frame 3102, STA1, STA2 and STA3 decrement their respective OBO counters by the number of RA-RUs allocated for their respective generations in the trigger frame (i.e., two RA-RUs for HE STAs, two for EHT STAs and four for EHT+ STAs). As a result, STA1, STA2 and STA3 will have their OBO counters all decremented to a zero value at the second round.

STA1, upon wining UORA contention at the second round, randomly selects one RA-RU from its eligible set of RA-RUs (RUs 1 and 2). In this case, STA1 select RU1, generate an UL TB PPDU according to the format specified in the corresponding User Info field associated with the RU1, in this case HE TB PPDU, and transmit an HE TB PPDU in RU1

STA2, upon wining UORA contention at the second round, randomly selects one RA-RU from its eligible set of RA-RUs (RUs 3 to 4). In this case, STA2 select RU4, generate an UL TB PPDU according to the format specified in the corresponding User Info field associated with the RU4, in this case EHT TB PPDU, and transmit an EHT TB PPDU in RU4.

STA3, upon winning UORA contention at the second round, randomly selects one RA-RU from its eligible set of RA-RUs (RUs 5 to 8). In this case, STA3 select RU7, generate an UL TB PPDU according to the format specified in the corresponding User Info field associated with the RU7, in this case EHT+TB PPDU, and transmit an EHT+TB PPDU in RU7.

In another example of the fourth embodiment, if the STAs of a generation are operating on different sections of a BSS's operating bandwidth, for example using the subchannel selective transmission (SST) feature, the same effect of limiting UORA contention to STAs of the same generation may be achieved without defining new special AID values by transmitting different Trigger frames for STAs of different generations in OFDMA manner such that STAs of each generation only receive Trigger frame with RA-RU for STAs of their own generation.

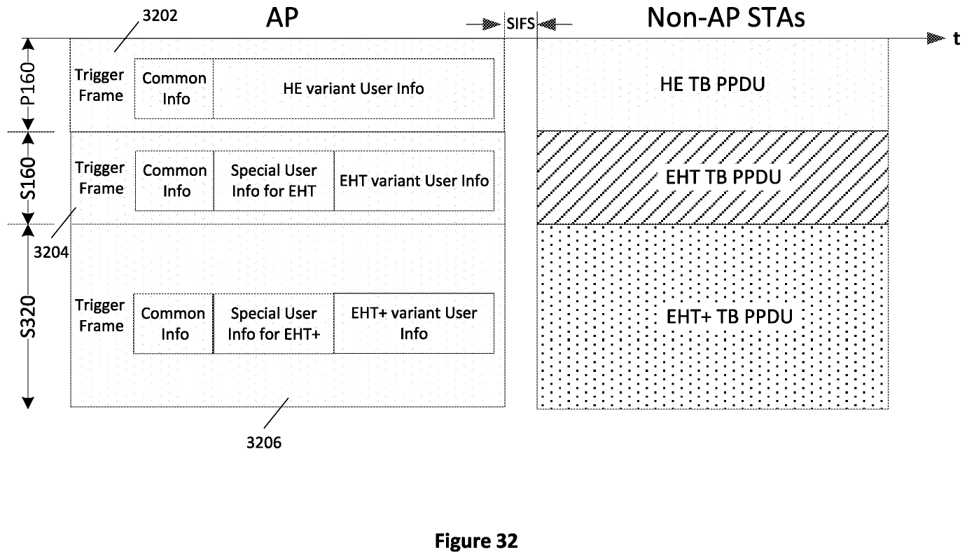

FIG. 32 shows respective RA-RU allocations for HE STAs, EHT STAs and EHT+ STAs by three trigger frames 3202, 3204, 3206 transmitted in OFDMA manner according to the fourth embodiment of the present disclosure. In this example, HE STAs operate in the P160, all EHT STAs operate within the S160 using the SST feature, and all EHT+ STAs operate within the S320 using the SST feature. The AP transmits three trigger frames 3202, 3204, 3206 comprising HE variant User Info fields, EHT variant User Info fields and EHT+ variant User Info fields respectively in OFDMA manner according to the operating bandwidth (P160, S160 and S320) of HE STAs, EHT STAs and EHT+ STAs. In this case the same AID12 values of 0 and 2045 of HE/EHT/EHT+ variant RA-RUs can be used to represent RA-RUs for STAs of all generations.

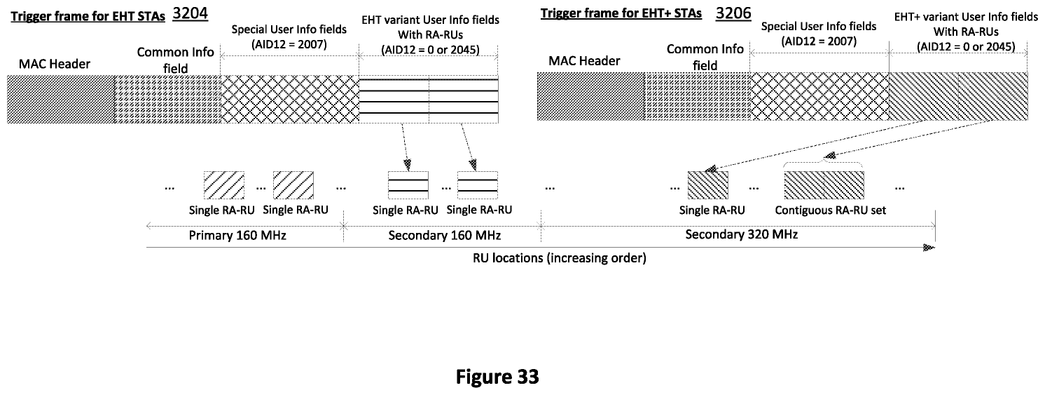

The two trigger frames 3204, 3206 transmitted in OFDMA manner to allocate RA-RUs to EHT STAs and EHT+ STAs are shown FIG. 33. The trigger frame for EHT STAs 3204 comprises a MAC Header, a Common Info field, a Special User Info field for EHT STAs (with AID12 subfield set to 2007 and PHY Version ID subfield set to 0), and two EHT variant User Info field allocating two RA-RUs in the S160 respectively; whereas the trigger frame for EHT+ STAs 3206 comprises a MAC Header, a Common Info field, a Special User Info field for EHT+ STAs (with AID12 subfield set to 2007 and PHY Version ID subfield set to 1), and two EHT variant User Info field allocating three RA-RUs in the S320 respectively. The trigger frame for HE STAs is not shown in the figure.

In the following paragraphs, a fifth embodiment of the present disclosure is explained with reference to multi-generation random access where a simultaneously UORA contention for UORAs of older and newer generations is possible STAs of newer generation. The fifth embodiment is a variation of the fourth embodiment where an AP allocates different RA-RUs for STAs of different generation in a trigger frame in that a STA of a generation can also simultaneously contend for UORA of earlier generation(s) (in addition to UORA for its own generation). In other words, the STA may simultaneously content for multiple UORAs, and upon winning multiple UORA contentions, the STA may choose any one to transmit its UL TB PPDU.

For example, an EHT STA can simultaneously contend for HE UORA (by acting as an HE STA) as well as EHT UORA (by acting as an EHT STA). Similarly, an EHT+ STA can simultaneously contend for HE UORA, EHT UORA and EHT+ UORA (by acting as an HE STA, an EHT STA and an EHT+ STA respectively). Note that this is based on the 802.11 inheritance requirement, i.e. an EHT STA is also an HE STA etc.

Advantageously, this results in a higher chance of winning UORA contention for STAs of newer generation. Since this scheme will result in higher chances of winning UORA contention for STAs of newer generation but the probability of collision will be higher in RA-RU for older generation, this may be limited to transmissions of frames of certain traffic types e.g., low latency traffic.

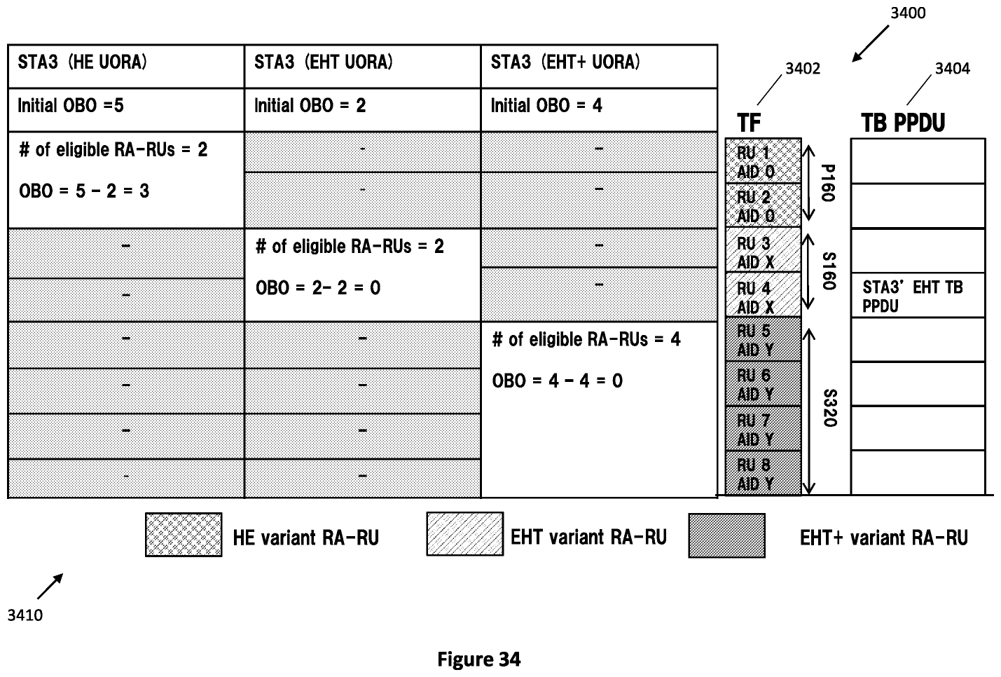

FIG. 34 shows a flow diagram 3410 illustrating UORA procedures of an EHT+ STA and a table illustrating a change in OBO counters of the EHT+ STA upon receiving a trigger frame(s) 3402, an allocation of RA-RUs by the trigger frame(s) 3402 and a selection of an RA-RU by the EHT+ STA for its uplink signal 3404 according to the fifth embodiment of the present disclosure. The gray rows under each STA's column in the table 3410 represent RUs that are not eligible for their UORA contention. Only the RUs that align with the rows in white are eligible RA-RUs for the STAs.

In the fifth embodiments, STA3 (EHT+ STA) can simultaneously contend for HE UORA, EHT UORA and EHT+ UORA. Assuming STA3 receive a OCW range, and the same EOCWₘᵢₙ and EOCWₘₐₓ is used to derive a contention window for UORA of all generations, an OCWₘᵢₙ of 7 and an OCWₘₐₓ of 31 is derived by STA3 for contenting UORA of all generations. Before the trigger frame 3402 is sent by the AP, the initial OBO values for HE, EHT and EHT+ UORA contentions of STA3 is 5, 2 and 4 respectively.

Upon receiving the trigger frame 3402, STA3 having pending frames for the AP decrement its OBO counters for HE, EHT and EHT+ UORA by their respective number of eligible RA-RUs indicated in the trigger frame for the STAs of the generations (i.e., two RA-RUs for HE STAs, two RA-RUs for EHT STAs and four RA-RUs for EHT+ STAs). The OBO counters for EHT UORA and EHT+ UORA decrements to 0, thus STA3 wins the EHT and EHT+ UORA contentions.

STA3, which wins both EHT and EHT+ UORA contention, randomly selects one RA-RU from its eligible set of RA-RUs for EHT STAs and EHT+ STA. In this case, STA3 selects RU4 (that for EHT STAs), generate an UL TB PPDU according to the format specified in the corresponding User Info field associated with the RU4, in this case EHT TB PPDU, and transmit am EHT TB PPDU in RU4.

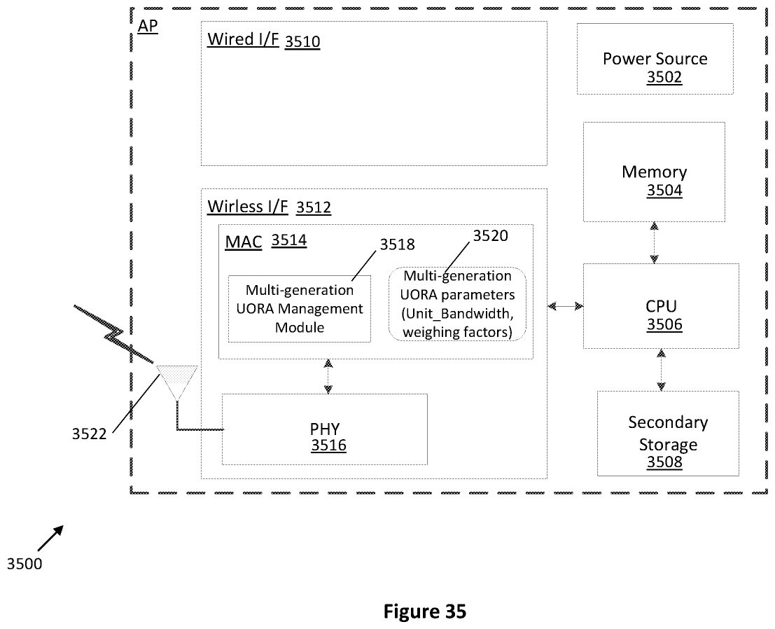

FIG. 35 shows an example configuration of a base communication apparatus 3500. The communication apparatus is implemented as an AP for multi-generation random access in accordance with the present disclosure. The base communication apparatus 3500 comprises a power source 3502, a memory 3504, a central processing unit (CPU) 3506 comprising at least one process, a secondary storage 3508, a wired interface (I/F) 3510 and a wireless I/F 3512. The memory 3504 may be a non-transitory computer-readable storage medium having stored therein data representing instructions executable by the at least one processor of the CPU 3506 to communicate with the wireless I/F 3512 to perform multi-generation random access according to various embodiments in the present disclosure. The Wireless I/F 3512 comprises a MAC layer 3514 and a PHY layer 3516. The PHY layer 3516 connects with a radio transmitter (not shown), a radio receiver (not shown) and an antenna used for transmitting/receiving signals to/from other communication apparatuses (e.g. STAs). Alternatively, the base communication apparatus 3500 may transmit/receive signals to/from other communication apparatus (e.g. STAs) via the Wired I/F 3510. The secondary storage 3508 may be configured to store AIDs of associated communication apparatus and a number of communication apparatuses of each generation contending for UORA.

The MAC layer 3514 further comprises a Multi-generation UORA Management Module 3518 and a Multi-generation UORA Parameters module 3520. In various embodiments, the Multi-generation UORA Parameters module 3520 is configured to generate UORA parameters such as a OCW Range (e.g. EOCWₘᵢₙ, EOCWₘₐₓ), a bandwidth unit parameter Unit_Bandwidth and a weighing factor(s) for STAs of each different generation. The Multi-generation UORA Management Module may be configured to determine a potential problem, in UORA of each generation, e.g. fairness issue, uneven distribution of collision probability and/or signaling issue in other communications, and generate a beacon frame comprising UORA parameters generated by the Multi-generation UORA Parameters module 3520 and a trigger frame(s) comprising a plurality of User Info fields allocating RA-RUs for STAs of different generations in accordance with various embodiments of the present disclosure to resolve the potential problem.

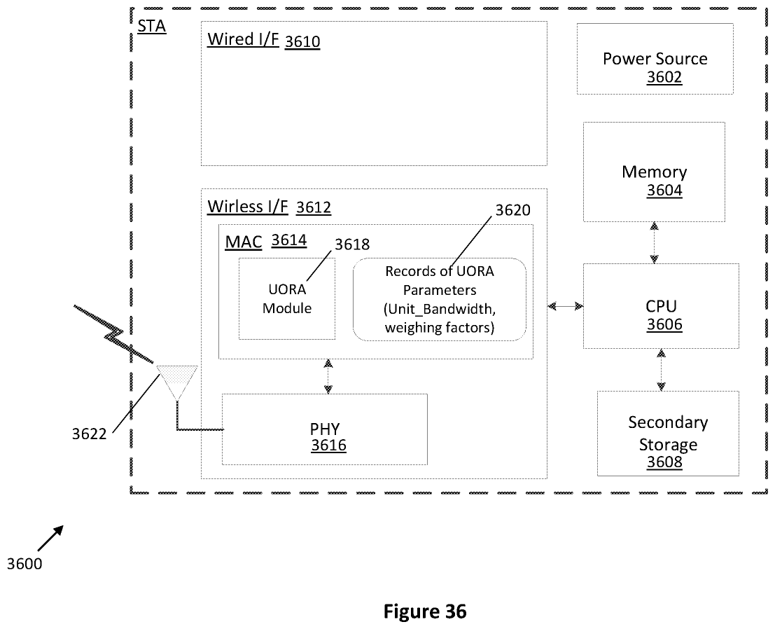

FIG. 36 shows an example configuration of a communication apparatus. The communication apparatus is implemented as a STA for multi-generation random access in accordance with the present disclosure. The communication apparatus 3600 comprises a power source 3602, a memory 3604, a central processing unit (CPU) 3606 comprising at least one process, a secondary storage 3608, a wired I/F 3610 and a wireless I/F 3612. The memory 3604 may be a non-transitory computer-readable storage medium having stored therein data representing instructions executable by the at least one processor of the CPU 3606 to communicate with the wireless I/F 3612 to perform multi-generation random access according to various embodiments in the present disclosure. The Wireless I/F 3612 comprises a MAC layer 3614 and a PHY layer 3616. The PHY layer 3616 connects with a radio transmitter (not shown), a radio receiver (not shown) and an antenna used for transmitting/receiving signals to/from other (base) communication apparatuses. Alternatively, the communication apparatus 3600 may transmit/receive signals to/from other (base) communication apparatus via the Wired I/F 3610.

The MAC layer 3614 further comprises a UORA Module 3618 and a Records of UORA Parameters module 3620. In various embodiments, the Records of UORA Parameters module 3520 is configured to store UORA parameters such as a OCW Range (e.g. EOCWₘᵢₙ, EOCWₘₐₓ), a bandwidth unit parameter Unit_Bandwidth and a weighing factor(s) of the communication apparatus either fixed by the standard or received from a base communication apparatus. In an embodiment, the secondary storage 3508 may be configured to BSS ID. The UORA Module 3618 may be configured to perform at least one of: extract other UORA parameters from the Records of UORA Parameters module 3520 and derive a contention window parameter (e.g. OCWₘᵢₙ and OCWₘₐₓ) based on its operating bandwidth and an initial value of a OBO counter, perform a UORA procedure similar to that described in FIGS. 22 and 30, count down the OBO counter, determine an UORA contention result, apply a weighing factor extracted from the Records of UORA Parameters module 3520 to a plurality of RA-RUs eligible/allocate to the communication apparatus 3600 and select one RA-RU from the plurality of RA-RUs to transmit an uplink signal.

The present disclosure can be realized by any kind of apparatus, device or system having a function of communication, which is referred as a communication device.

The present disclosure can be realized by software, hardware, or software in cooperation with hardware. Each functional block used in the description of each embodiment described above can be partly or entirely realized by a large-scale integration (LSI) such as an integrated circuit, and each process described in each embodiment may be controlled partly or entirely by the same LSI or a combination of LSIs. The LSI may be individually formed as integrated circuit chips, or one chip may be formed so as to include a part or all of the functional blocks. The LSI may include a data input and output coupled thereto. The LSI may be referred to as an integrated circuit (IC), a system LSI, a super LSI, or an ultra-LSI depending on a difference in the degree of integration. However, the technique of implementing an integrated circuit is not limited to the LSI and may be realized by using a dedicated circuit, a general-purpose processor, or a special purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. He present disclosure can be realized as digital processing or analogue processing. If future integrate circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include a radio frequency (RF) module including amplifiers, RF modulators/demodulators and the like, and one or more amplifiers, RF modulators/demodulators and the like, and one or more antennas. The processing/control circuitry may include power management circuitry which may comprise dedicated circuitry, a processor and instructions for power management control as either firmware or instructions stored in a memory coupled to the processor.

Some non-limiting examples of such communication device include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication device is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication device may comprise an apparatus such as a controller or a sensor which is coupled to a communication apparatus performing a function of communication described in the present disclosure. For example, the communication device may comprise a controller or a sensor that generates control signals or data signals which are used by a communication apparatus performing a communication function of the communication device.

The communication device also may include an infrastructure facility, such as a base station, an access point, and any other apparatus, device or system that communicates with or controls apparatuses such as those in the above non-limiting examples.

Thus, it can be seen that the present embodiments provide communication apparatuses and methods for multi-generation random access in order to fully realize the throughput gains of multi-generation random access, in particular for uplink transmissions.

While exemplary embodiments have been presented in the foregoing detailed description of the present embodiments, it should be appreciated that a vast number of variations exist. It should further be appreciated that the exemplary embodiments are examples, and are not intended to limit the scope, applicability, operation, or configuration of this disclosure in any way. Rather, the foregoing detailed description will provide those skilled in the art with a convenient road map for implementing exemplary embodiments, it being understood that various changes may be made in the function and arrangement of steps and method of operation described in the exemplary embodiments and modules and structures of devices described in the exemplary embodiments without departing from the scope of the subject matter as set forth in the appended claims.

1. A communication apparatus comprising:
a receiver which, in operation, receives, from a base communication apparatus, an uplink OFDMA (Orthogonal Frequency Division Multiple Access) based random access (UORA) parameter and a trigger frame comprising user information fields allocating a plurality of random access resource units (RA-RUs); and
circuitry which is configured to, in operation, derive a contention window parameter from the UORA parameter based on an operating bandwidth of the communication apparatus, determine an UORA result to access the plurality of RA-RUs based on the contention window parameter and select one RA-RU from the plurality of RA-RUs according to the determination; and
a transmitter which, in operation, transmits an uplink signal on the one RA-RU.

2. The communication apparatus according to claim 1, wherein the circuitry is further configured to:
calculate a scaling factor based on the operating bandwidth of the communication apparatus and a bandwidth unit; and
derive the contention window parameter based on the scaling factor, the user information fields allocating one or more first RA-RUs allocated for a first type of communication apparatuses, the first type of communication apparatuses comprising the communication apparatus, the user information fields further allocating one or more second RA-RUs allocated for a second, different type of communication apparatuses, the communication apparatus configured to select the one RA-RU from the one or more first RA-RUs and the one or more second RA-RUs according to the determination.

3. The communication apparatus according to claim 2, wherein the UORA parameter comprises a bandwidth unit and the circuitry is further configured to count down a UORA backoff (OBO) counter by a count of both first RA-RUs allocated for a first type of communication apparatuses and the one or more second RA-RUs allocated for the second type of communication apparatuses when determining an UORA result.

4. The communication apparatus according to claim 2, wherein the bandwidth unit is set based on a channel bandwidth of a basic service set of the second type of communication apparatuses operated by the base communication apparatus in a same frequency band on a channel which overlaps that of a basic service set of the first type of communication apparatuses.

5. The communication apparatus according to claim 1, wherein the receiver further receives a weighing factor from the base communication apparatus, and the circuitry is further configured to apply the weighing factor to the plurality of RA-RUs when selecting the one RA-RU from the plurality of RA-RUs according to the determination.

6. The communication apparatus according to claim 1, wherein the user information fields allocating one or more first RA-RUs allocated for a first type of communication apparatuses, the first type of communication apparatuses comprising the communication apparatus, the user information fields further allocating one or more second RA-RUs allocated for a second, different type of communication apparatuses, and the circuitry is further configured to:
count down a UORA backoff (OBO) counter by a count of the one or more second RA-RUs allocated for the second type of communication apparatuses when determining an UORA result.

7. The communication apparatus according to claim 1, wherein the user information fields allocating one or more first RA-RUs allocated for a first type of communication apparatuses, the first type of communication apparatuses comprising the communication apparatus, the user information fields further allocating one or more second RA-RUs allocated for a second, different type of communication apparatuses, the circuitry is configured to:
count down a UORA backoff (OBO) counter by a count of the first RA-RUs allocated for the first type of communication apparatuses when determining an UORA result; and
randomly select the one RA-RU from the one or more RA-RUs allocated for the first type of communication apparatuses according to the determination.

8. The communication apparatus according to claim 1, wherein the user information fields allocating one or more first RA-RUs allocated for a first type of communication apparatuses, the first type of communication apparatuses comprising the communication apparatus, the user information fields further allocating one or more second RA-RUs allocated for a second, different type of communication apparatuses, and the UORA parameters comprises first UORA parameters for the first type of communication apparatuses and second UORA parameters for the second type of communication apparatuses; the circuitry is further configured to:
derive respective contention window parameters from the first UORA parameters and the second UORA parameters;
determine the UORA result to access the one or more first RA-RUs and the one or more second RA-RUs based on the respective contention window parameters; and
select the one RA-RU from the one or more first RA-RUs and the one or more second RA-RUs according to the determination.

9. A base communication apparatus comprising:
circuitry which is configured to, in operation, generate a trigger frame comprising user information fields allocating a plurality of random access resource units (RA-RUs), the user information fields allocating one or more first RA-RUs allocated for a first type of communication apparatuses, and the user information fields further allocating one or more second RA-RUs allocated for a second, different type of communication apparatuses;
a transmitter which, in operation, transmits an uplink OFDMA (Orthogonal Frequency Division Multiple Access) based random access (UORA) parameter and the trigger frame to one or more communication apparatuses.

10. The base communication apparatus according to claim 9, wherein the UORA parameter comprises a bandwidth unit for each of the one or more communication apparatuses to derive a contention window parameter and to determine an UORA result to access the plurality of RA-RUs based on the contention window parameter.

11. The based communication apparatus according to claim 10, wherein the circuitry is configured to set the bandwidth unit based on a width of a basic service set of the second type of communication apparatuses operated by the base communication apparatus in a same frequency band on a channel which overlaps that of a basic service set of the first type of the communication apparatuses.

12. The base communication apparatus according to claim 9, wherein the transmitter further transmits a weighing factor to each of the one or more communication apparatuses to apply to the plurality of RA-RUs and select one RA-RU from the plurality of RA-RUs for an uplink signal transmission.

13. The base communication apparatus according to claim 9, wherein the circuitry is further configured to indicate an uplink signal format in each of the user information fields according to a frequency position of a corresponding RA-RU of the plurality of RA-RUs allocated by the each of the user information fields.

14. The base communication apparatus according to claim 9, wherein the circuitry is further configured to set an associated identifier subfield of each of the one or more user information fields allocating the one or more first RA-RUs to a value other than 0 or 2045.

15. The base communication apparatus according claim 9, wherein the circuitry is further configured to set a physical version identifier subfield of each of the one or more user information fields allocating the one or more first RA-RUs to indicate a subtype of the first type of communication apparatuses.

16. The base communication apparatus according to claim 9, wherein the circuitry is further configured to set an associated identifier subfield and a bit number 25 of each of the one or more user information fields allocating the one or more first RA-RUs to a value of 2046 and a value of 1.

17. The base communication apparatus according to claim 16, wherein the circuitry is further configured to set a bit number 26 of each of the one or more user information fields allocating the one or more first RA-RUs to indicate whether each of the first type of communication apparatuses is associated with the base communication apparatus.

18. The base communication apparatus according to claim 9, wherein the user information fields further comprises a padding user field with an associated identifier set to a value of 4095 between one of the user information fields allocating the one or more first RA-RUs, and another one of the user information fields allocating the one or more second RA-RUs.

19. A communication method comprising:
receiving an uplink OFDMA (Orthogonal Frequency Division Multiple Access) based random access (UORA) parameter and a trigger frame comprising user information fields allocating a plurality of random access resource units (RA-RUs);
deriving a contention window parameter from the UORA parameter based on an operating bandwidth;
determining an UORA result to access the plurality of RA-RUs based on the contention window parameter;
selecting one RA-RU from the plurality of RA-RUs according to the determination; and
transmitting an uplink signal on the one RA-RU.
